(19) United States
(12) Patent Application Publication
(10) Pub. No.: US 2026/0089396 A1
(43) Pub. Date: Mar. 26, 2026

(54) INFORMATION PROCESSING APPARATUS AND CONTROL METHOD

(71) Applicant: CANON KABUSHIKI KAISHA, Tokyo (JP)

(72) Inventors: SHIGEO OGAWA, Kanagawa (JP); RIE MYOJIN, Tokyo (JP)

(21) Appl. No.: 19/331,408

(22) Filed: Sep. 17, 2025

(30) Foreign Application Priority Data
Sep. 26, 2024 (JP) 2024-167823

(51) Int. Cl. H04N 23/695; G06V 10/75; H04N 23/60; H04N 23/66

(52) U.S. Cl. CPC H04N 23/695; G06V 10/751; H04N 23/64; H04N 23/66

(57) ABSTRACT

An information processing apparatus communicates with a plurality of image capture apparatuses each capable of changing a shooting direction, obtains an image shot in each shooting direction from the plurality of image capture apparatuses, compares the images obtained from the plurality of image capture apparatuses, and controls, based on a result of the comparison, such that the shooting directions of the plurality of image capture apparatuses do not overlap.

### BACKGROUND

### Field of the Technology

The present disclosure relates to control of a plurality of image capture apparatuses.

### Description of the Related Art

There is known an automatic shooting camera that has a function of automatically detecting a subject from a captured image and automatically performing shooting. Japanese Patent Laid-Open No. 2013-223104 describes that in a case where the image capture regions of a plurality of cameras overlap, a camera that captures an image optimum to image processing for the overlapping image capture regions is selected. Japanese Patent Laid-Open No. 2020-22052 describes that when causing a plurality of cameras to shoot in synchronism, an information processing apparatus is notified, based on the shooting enabling ranges of the plurality of cameras, of shooting areas that can be covered and shooting areas that cannot be covered.

In Japanese Patent Laid-Open Nos. 2013-223104 and 2020-22052, when a plurality of cameras perform automatic shooting, the shooting target or shooting range may overlap between the cameras, similar images may be shot by a plurality of cameras, or shooting may be done with a bias (over-focus) on the same subject (shooting the same subject over and over again).

### SUMMARY

The present disclosure has been made in consideration of the aforementioned problems, and is directed to an information processing apparatus comprising: a memory and at least one processor which function as: a communication unit that communicates with a plurality of image capture apparatuses each capable of changing a shooting direction; an obtaining unit that obtains an image shot in each shooting direction from the plurality of image capture apparatuses; a comparison unit that compares the images obtained from the plurality of image capture apparatuses; and a control unit that controls, based on a result of the comparison, such that the shooting directions of the plurality of image capture apparatuses do not overlap.

The present disclosure is directed to a control method of an information processing apparatus that communicates with a plurality of image capture apparatuses each capable of changing a shooting direction, comprising: obtaining an image shot in each shooting direction from the plurality of image capture apparatuses; comparing the images obtained from the plurality of image capture apparatuses; and controlling, based on a result of the comparison, such that the shooting directions of the plurality of image capture apparatuses do not overlap.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are views schematically exemplifying the outer appearance of an image capture apparatus according to a present embodiment;

FIG. 2 is a block diagram exemplifying the internal configuration of the image capture apparatus according to the present embodiment;

FIG. 3 is a view illustrating the connection relationship between the image capture apparatus and an external apparatus according to the present embodiment;

FIG. 4 is a block diagram exemplifying the internal configuration of the external apparatus according to the present embodiment;

FIG. 5 is a view schematically exemplifying the outer appearances of the image capture apparatus and the external apparatus according to the present embodiment;

FIG. 6 is a block diagram exemplifying the internal configuration of the external apparatus according to the present embodiment;

FIG. 7 is a flowchart exemplifying first control processing according to the present embodiment;

FIG. 8 is a flowchart exemplifying second control processing according to the present embodiment;

FIG. 9 is a flowchart illustrating automatic shooting mode processing according to the present embodiment;

FIGS. 10A to 10D are views illustrating shooting areas according to the present embodiment;

FIG. 11 is a view exemplifying the configuration of a neural network according to the present embodiment;

FIG. 12 is a view illustrating an image selection method according to the present embodiment;

FIG. 13 is a flowchart exemplifying learning mode determination processing according to the present embodiment;

FIG. 14 is a flowchart exemplifying learning mode processing according to the present embodiment;

FIG. 15 is a view exemplifying the configuration of a system including a plurality of image capture apparatuses and an external apparatus according to the present embodiment;

FIG. 16 is a view exemplifying the image capture ranges of the plurality of image capture apparatuses according to the present embodiment;

FIGS. 17A to 17C are views exemplifying omnidirectional images obtained by the plurality of image capture apparatuses according to the present embodiment;

FIG. 18 is a flowchart exemplifying control processing of the plurality of image capture apparatuses according to the present embodiment;

FIG. 19 is a flowchart exemplifying control processing of an information processing apparatus to which the plurality of image capture apparatuses according to the present embodiment are connected;

FIG. 20 is a flowchart exemplifying a shooting area determination processing according to the present embodiment;

FIGS. 21A and 21B are views exemplifying shooting area determination results according to the present embodiment;

FIGS. 22A and 22B are flowcharts exemplifying shooting possibility determination processing based on image similarity according to the present embodiment;

FIG. 23 is a flowchart exemplifying image similarity determination processing according to the present embodiment;

FIGS. 24A and 24B are views exemplifying image similarity determination results according to the present embodiment;

FIGS. 25A and 25B are views exemplifying shooting possibility determination results based on image similarity according to the present embodiment;

FIGS. 26A and 26B are flowcharts exemplifying shooting possibility determination processing based on a bias on a subject according to the present embodiment;

FIGS. 27A and 27B are views exemplifying subject determination results according to the present embodiment;

FIGS. 28A and 28B are views exemplifying shooting possibility determination results based on a bias on a subject according to the present embodiment;

FIGS. 29A and 29B are views exemplifying final shooting possibility settings according to the present embodiment; and

FIGS. 30A and 30B are views illustrating a modification of the shooting possibility determination processing based on image similarity according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An embodiment in which an image processing apparatus according to the present disclosure is applied to an image capture apparatus such as a digital camera will be described below. The digital camera according to the present embodiment is an automatic shooting camera that has a function of automatically detecting a subject from a captured image and automatically performing shooting. In the present embodiment, an example in which when a plurality of cameras perform automatic shooting, control is performed such that the shooting target or shooting range does not overlap between the cameras will be described.

### Apparatus Configuration

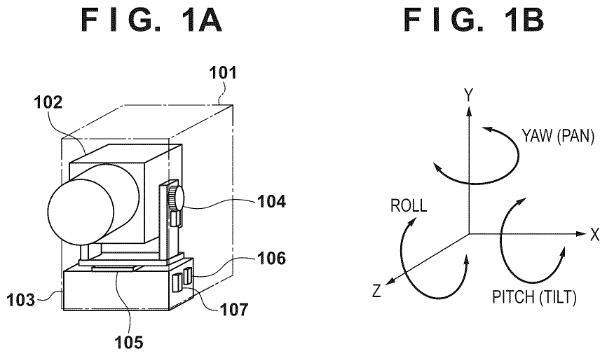

The configurations of a system and apparatuses according to the present embodiment will be described first with reference to FIGS. 1A and 1B.

FIG. 1A is a view schematically exemplifying the outer appearance of an image capture apparatus according to the present embodiment.

An image capture apparatus (to be referred to as a camera hereinafter) 101 according to the present embodiment includes an imaging unit 102 and a support portion 103. Also, the camera 101 according to the present embodiment is provided with operation units such as a power button and a shutter button (none are shown).

The imaging unit 102 includes an optical system that captures an image of a subject. The optical system includes a lens group that forms an image of a subject on an image sensor 206, and the image sensor 206 formed by a CCD or a CMOS that converts an optical image of the subject into an electrical signal. The imaging unit 102 is rotatably attached to the support portion 103. More specifically, the imaging unit 102 is attached to the support portion 103 such that it can be rotationally driven by a first rotation mechanism 104 and a second rotation mechanism 105, and the shooting direction (to be referred to as an angle of shooting direction hereinafter) of the imaging unit 102 can be changed.

The first rotation mechanism 104 is a tilt unit that rotationally drives the imaging unit 102 in the tilt direction. The second rotation mechanism 105 is a pan unit that rotationally drives the imaging unit 102 in the pan direction.

Also, an angular velocity meter 106 and an accelerometer 107 are provided on the support portion 103. For example, a gyro sensor is used for the angular velocity meter 106 and, for example, an acceleration sensor is used for the accelerometer 107.

FIG. 1B is a view illustrating the relationship between the three-dimensional orthogonal coordinate system of the camera 101 and the rotation direction of the camera 101.

The X-axis (horizontal axis), the Y-axis (vertical axis), and the Z-axis (an axis in the depth direction) of the three-dimensional orthogonal coordinate system are defined with respect to the position of the support portion 103. In the present embodiment, a direction about the X-axis is defined as the pitch direction, a direction about the Y-axis is defined as the yaw direction, and a direction about the Z-axis is defined as the roll direction.

The tilt unit 104 includes a driving mechanism such as a motor capable of rotating the imaging unit 102 in the pitch direction shown in FIG. 1B. The pan unit 105 includes a driving mechanism such as a motor capable of rotating the imaging unit 102 in the yaw direction shown in FIG. 1B. The camera 101 includes a driving mechanism capable of rotating the imaging unit 102 at least in the directions about two axes of the three-dimensional orthogonal coordinate system.

The angular velocity meter 106 outputs a detection signal of an angular velocity. The accelerometer 107 outputs a detection signal of an acceleration. Based on the detection signals of the angular velocity meter 106 and the accelerometer 107, a vibration of the camera 101 is detected, and the tilt unit 104 and the pan unit 105 are rotationally driven. Thus, a shake and tilt of the imaging unit 102 are corrected. Also, based on the detection results of the angular velocity meter 106 and the accelerometer 107 during a predetermined period, the moving direction and the moving distance of the camera 101 are detected.

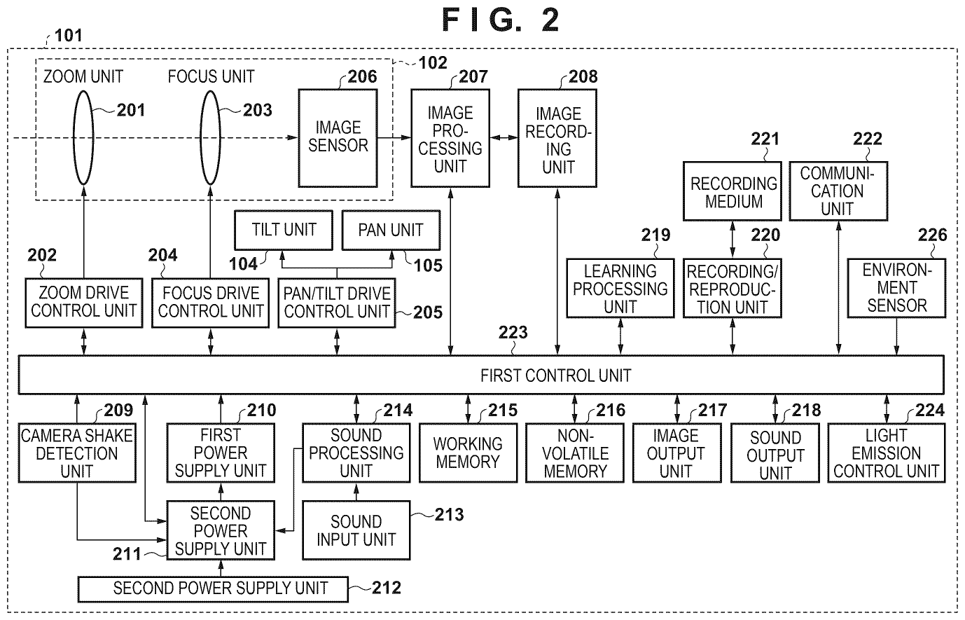

FIG. 2 is a block diagram exemplifying the internal configuration of the camera 101 according to the present embodiment.

A first control unit 223 includes a processor (main processor) such as a Central Processing Unit (CPU) or a Micro-Processing Unit (MPU), which performs arithmetic processing or control processing of the camera 101.

A working memory 215 includes a Dynamic RAM or a Static RAM, and constants and variables for the operation of the first control unit 223 and control programs read out from a nonvolatile memory 216 are loaded to the working memory 215.

The nonvolatile memory 216 includes a flash ROM and stores constants for the operation of the first control unit 223 and control programs.

The first control unit 223 loads a control program stored in the nonvolatile memory 216 to the working memory 215 and executes it, thereby performing control of the components of the camera 101 or data transfer control between them.

A zoom unit 201 includes a zoom lens that performs magnification (enlargement/reduction of a formed subject image). A zoom drive control unit 202 drives and controls the zoom unit 201 and also detects the focal length at the time of drive control.

A focus unit 203 includes a focus lens that performs focus adjustment. A focus drive control unit 204 drives and controls the focus unit 203.

The image sensor 206 converts charge information according to the amount of light that enters via the lens group into an analog image signal and outputs it to an image processing unit 207. Note that the zoom unit 201, the focus unit 203, and the image sensor 206 are arranged in the imaging unit 102.

The image processing unit 207 performs image processing for image data obtained by converting the analog image signal into a digital signal. The image processing is distortion correction, white balance adjustment, color interpolation processing, or the like, and the image processing unit 207 outputs the image data after the image processing.

An image recording unit 208 obtains the image data output from the image processing unit 207. The image data is converted into a recording format such as Joint Photographic Experts Group (JPEG) and temporarily stored in the working memory 215 or transmitted to an image output unit 217 to be described later.

A pan/tilt drive control unit 205 drives the tilt unit 104 and the pan unit 105 to rotate the imaging unit 102 in the tilt direction and the pan direction.

A camera shake detection unit 209 includes the angular velocity meter 106 that detects the angular velocity of the camera 101 in triaxial directions, and the accelerometer 107 that detects the acceleration of the camera 101 in triaxial directions. The first control unit 223 calculates the rotation angle of the imaging unit 102, the shake amount of the camera 101, and the like based on the detection signal of the camera shake detection unit 209.

A sound input unit 213 obtains a sound signal on the periphery of the camera 101 by a microphone provided in the camera 101, converts it into a digital sound signal, and transmits the digital sound signal to a sound processing unit 214. The sound processing unit 214 performs processing associated with a sound, for example, optimization processing for the digital sound signal received from the sound input unit 213. The sound signal processed by the sound processing unit 214 is transmitted to the working memory 215 by the first control unit 223. The working memory 215 temporarily stores the image signal and the sound signal obtained by the image processing unit 207 and the sound processing unit 214.

The image processing unit 207 and the sound processing unit 214 read out the image signal and the sound signal temporarily stored in the working memory 215, and performs encoding of the image signal and encoding of the sound signal, thereby generating a compressed image signal and a compressed sound signal. The first control unit 223 transmits the compressed image signal and the compressed sound signal to a recording/reproduction unit 220.

The recording/reproduction unit 220 records, in a recording medium 221, the compressed image signal and the compressed sound signal generated by the image processing unit 207 and the sound processing unit 214, control data associated with shooting, and the like. When the sound signal is not compressed-coded, the first control unit 223 transmits the sound signal generated by the sound processing unit 214 and the compressed image signal generated by the image processing unit 207 to the recording/reproduction unit 220 and records these in the recording medium 221.

The recording medium 221 is incorporated in the camera 101 or is detachable from the camera 101, and can record various kinds of data such as the compressed image signal, the compressed sound signal, and the sound signal generated by the camera 101. As the recording medium 221, a medium whose capacity is larger than that of the nonvolatile memory 216 is used. For example, a hard disk, an optical disk, a magnetooptical disk, a CD-R, a DVD-R, a magnetic tape, a nonvolatile semiconductor memory, or a flash memory is used as the recording medium 221. However, the present disclosure is not limited to this, and a recording medium of any type can be used.

The recording/reproduction unit 220 reads out the compressed image signal, the compressed sound signal, and the sound signal recorded in the recording medium 221 and reproduces these. The first control unit 223 transmits the compressed image signal and the compressed sound signal read out from the recording medium 221 to the image processing unit 207 and the sound processing unit 214. The image processing unit 207 and the sound processing unit 214 temporarily store the compressed image signal and the compressed sound signal in the working memory 215, decodes these in accordance with a predetermined procedure, and transmits the decoded signals to the image output unit 217.

The sound input unit 213 includes a plurality of microphones. The sound processing unit 214 can detect the direction of a sound with respect to a plane on which the plurality of microphones are installed, and detection information is used for a search of a subject or automatic shooting (to be described later). The sound processing unit 214 detects specific voice commands. The voice commands are, for example, several commands registered in advance or commands based on a registered voice for which the user can register a specific voice in the camera. Also, the sound processing unit 214 performs sound scene recognition. In the sound scene recognition, sound scene determination processing is executed by a network that has performed machine learning in advance based on an enormous amount of sound data. For example, learning models for detecting specific scenes, such as “they are cheering”, “they are clapping”, or “they are speaking out” are set in the sound processing unit 214, and a specific sound scene or a specific voice command is detected. Upon detecting the specific sound scene or specific voice command, the sound processing unit 214 outputs a trigger signal by the specific speech recognition to the first control unit 223 or a second control unit 211.

The second control unit 211 is a processor (sub processor) provided separately from the first control unit 223, and controls power supply to the first control unit 223. A first power supply unit 210 and a second power supply unit 212 supply power to operate the first control unit 223 and the second control unit 211. By pressing the power button provided on the camera 101, first, power is supplied to both the first control unit 223 and the second control unit 211. As will be described later, the first control unit 223 also performs control to turn off power supply from the first power supply unit 210. The second control unit 211 is operating even in a state in which the first control unit 223 is not operating, and detection signals from the camera shake detection unit 209 and the sound processing unit 214 are input to the second control unit 211. The second control unit 211 determines, based on various kinds of input information, whether to activate the first control unit 223. Upon determining to activate the first control unit 223, the second control unit 211 instructs the first power supply unit 210 to supply power to the first control unit 223.

A sound output unit 218 includes a speaker incorporated in the camera 101, and outputs a sound of a preset pattern from the speaker at the time of, for example, shooting.

A light emission control unit 224 controls light emission of LEDs (light emitting diodes) provided on the camera 101. Also, the light emission control unit 224 controls light emission of the LEDs based on a preset lighting pattern or blinking pattern at the time of shooting or the like.

The image output unit 217 includes, for example, an image output terminal, and outputs an image signal to display it on an external display connected to the camera 101. Note that the sound output unit 218 and the image output unit 217 may be one coupled terminal, for example, an High-Definition Multimedia Interface (HDMI®) terminal.

A learning processing unit 219 executes learning processing using learning models and learning parameters. The learning processing can be executed by an image processing processor such as a Graphics Processing Unit (GPU). The GPU is a processor capable of performing an enormous amount of product-sum operations, and has an arithmetic processing capability to perform the matrix operation or the like of a neural network in a short time.

A communication unit 222 includes an interface that performs communication between the camera 101 and an external apparatus. The communication unit 222 transmits/receives data such as a sound signal, an image signal, a compressed image signal, and a compressed sound signal to/from, for example, an external apparatus. The communication unit 222 receives a command of shooting start or shooting end or a control signal associated with shooting such as pan, tilt, or zoom and outputs it to the first control unit 223. The operation of the camera 101 can thus be controlled based on an instruction from the external apparatus. In addition, the communication unit 222 transmits/receives, between the camera 101 and the external apparatus, information such as a learning model or a learning parameter to be used in learning processing by the learning processing unit 219. The communication unit 222 includes a wireless communication module such as an infrared communication module, a Bluetooth® communication module, a wireless LAN communication module, a Wireless USB®, or a GPS receiver.

An environment sensor 226 detects the state of the environment on the periphery of the camera 101 at a predetermined period. The environment sensor 226 includes, for example, the following sensors.
Temperature sensor that detects the temperature on the periphery of the camera 101
Atmospheric pressure sensor that detects the atmospheric pressure on the periphery of the camera 101
Illuminance sensor that detects the brightness on the periphery of the camera 101
Humidity sensor that detects the humidity on the periphery of the camera 101
Ultraviolet radiation sensor that detects the amount of ultraviolet radiation on the periphery of the camera 101

In addition to various kinds of information (temperature information, atmospheric pressure information, illuminance information, humidity information, and ultraviolet radiation information) detected by the sensors, the environment sensor 226 can calculate change rates at a predetermined time interval from the various kinds of information. The temperature change amount, the atmospheric pressure change amount, the illuminance change amount, the humidity change amount, and the ultraviolet radiation change amount can be used for determination of automatic shooting or the like.

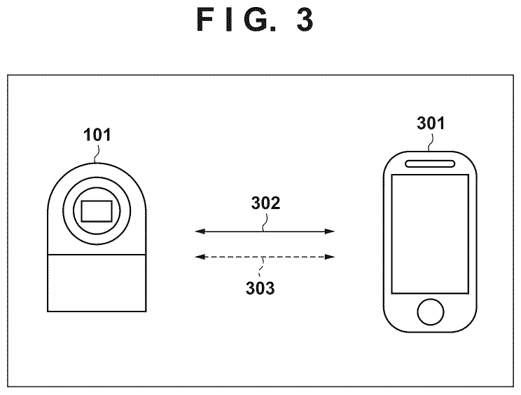

The connection relationship between the camera 101 and an external apparatus 301 will be described next with reference to FIG. 3.

FIG. 3 is a view exemplifying a system configuration in which the camera 101 and the external apparatus 301 are connected such that they can wirelessly communicate with each other.

The camera 101 according to the present embodiment is, for example, an automatic shooting camera installed at an arbitrary position. The external apparatus 301 according to the present embodiment is an information processing apparatus capable of controlling the angles of shooting direction of a plurality of cameras 101. The information processing apparatus is, for example, a smart device including a wireless communication module such as Bluetooth® or a wireless LAN. However, the information processing apparatus is not limited to this, and may be a personal computer (a laptop PC or a tablet PC), a cloud server, or the like. Also, the external apparatus 301 according to the present embodiment may be one of the plurality of cameras 101.

In the example shown in FIG. 3, the camera 101 and the external apparatus 301 perform first communication 302 (solid line arrow) and second communication 303 (dotted line arrow). The first communication 302 is, for example, wireless local area network (LAN) communication complying with the IEEE 802.11 standard. The second communication 303 is, for example, communication having a master-slave relationship between a control station and a tributary station, like Bluetooth® Low Energy (to be referred to as BLE hereinafter). Note that the wireless LAN and BLE are examples of communication methods. If the camera 101 and the external apparatus 301 have two or more communication functions and, for example, one communication function of performing communication in the relationship of the control station and the tributary station can control the other communication function, another communication method may be used. However, the first communication 302 using the wireless LAN or the like can perform communication at a higher speed than the second communication 303 by BLE or the like. Also, the second communication 303 has at least one of smaller power consumption and a shorter communication enable distance than the first communication 302.

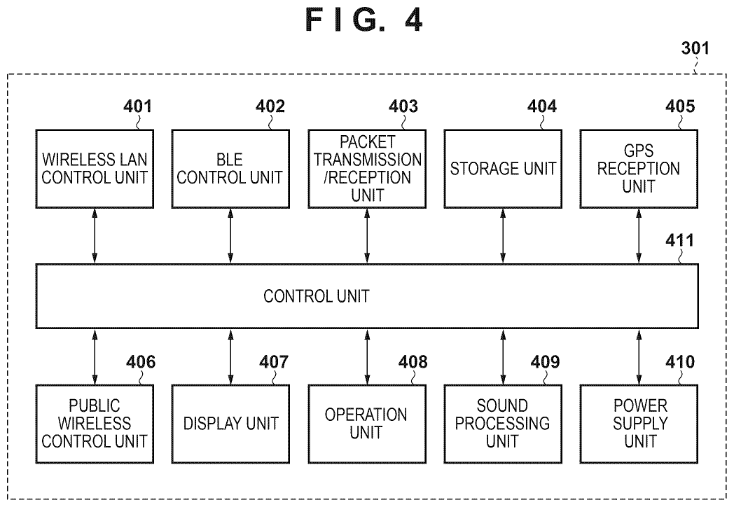

The internal configuration of the external apparatus 301 will be described next with reference to FIG. 4.

FIG. 4 is a block diagram exemplifying the internal configuration of the external apparatus 301.

A wireless LAN control unit 401 performs RF control of a wireless LAN, communication processing, driver processing for performing various kinds of control of communication by a wireless LAN complying with the IEEE 802.11 standard series, and protocol processing associated with communication by a wireless LAN.

A BLE control unit 402 performs RF control of BLE, communication processing, driver processing for performing various kinds of control of communication by BLE, and protocol processing associated with communication by BLE.

A public wireless control unit 406 performs RF control of public wireless communication, communication processing, driver processing for performing various kinds of control of public wireless communication, and protocol processing associated with public wireless communication. The public wireless communication is communication complying with, for example, the International Multimedia Telecommunications (IMT) standard or the Long Term Evolution (LTE) standard.

A packet transmission/reception unit 403 executes communication by a wireless LAN and BLE, and at least one of transmission and reception of a packet associated with public wireless communication. Note that an example in which the external apparatus 301 according to the present embodiment performs at least one of transmission and reception of a packet in communication will be described but, except for the packet exchange, another communication method such as line exchange may be used.

A control unit 411 includes a processor such as a CPU or an MPU for performing arithmetic processing and control processing of the external apparatus 301, and executes control programs stored in a storage unit 404, thereby controlling the components of the external apparatus 301.

The storage unit 404 is a memory that stores various kinds of information such as control programs to be executed by the control unit 411 and parameters necessary for communication. Various kinds of operations to be described later are implemented by executing the control programs stored in the storage unit 404 by the control unit 411.

A Global Positioning System (GPS) reception unit 405 receives a GPS signal notified from an artificial satellite, analyzes the GPS signal, and estimates the current position (longitude/latitude information) of the external apparatus 301. Alternatively, using a Wi-Fi Positioning System (WPS) or the like, the GPS reception unit 405 estimates the current position of the external apparatus 301 based on the information of a wireless network existing on the periphery. For example, assume a case where current GPS information obtained by the GPS reception unit 405 is located in a preset position range (a range of a predetermined radius with respect to a detection position as the center), or a position change of a predetermined amount or more occurs in the GPS information. In this case, the BLE control unit 402 notifies the camera 101 of moving information, and the information is used as a parameter for automatic shooting or automatic editing to be described later.

A display unit 407 has a function capable of outputting visible information, like a liquid crystal display device (LCD) or an LED, or outputting a sound like a speaker, and presents various kinds of information.

An operation unit 408 includes a button and the like, which accept user operations for the external apparatus 301. Note that the display unit 407 and the operation unit 408 may be formed by, for example, a touch panel.

A sound processing unit 409 obtains information of a user's voice by, for example, a microphone incorporated in the external apparatus 301. The sound processing unit 409 may be configured to identify an instruction by user's utterance by speech recognition processing. The sound processing unit 409 may be configured to obtain a voice command by user's utterance using a dedicated application of the external apparatus 301. In this case, a specific voice command to be recognized by the sound processing unit 214 of the camera 101 can be registered by the first communication 302 of the wireless LAN. A power supply unit 410 supplies necessary power to each unit of the external apparatus 301.

The camera 101 and the external apparatus 301 perform data transmission/reception by the wireless LAN control unit 401 and the BLE control unit 402. For example, transmission/reception of data such as a sound signal, an image signal, a compressed sound signal, and a compressed image signal is performed. In addition, transmission of a shooting instruction or the like, transmission of voice command registration data, transmission of a predetermined position detection notification based on a GPS signal, transmission of a position moving notification, and the like from the external apparatus 301 to the camera 101 are performed. Also, transmission/reception of learning data is performed using a dedicated application of the external apparatus 301.

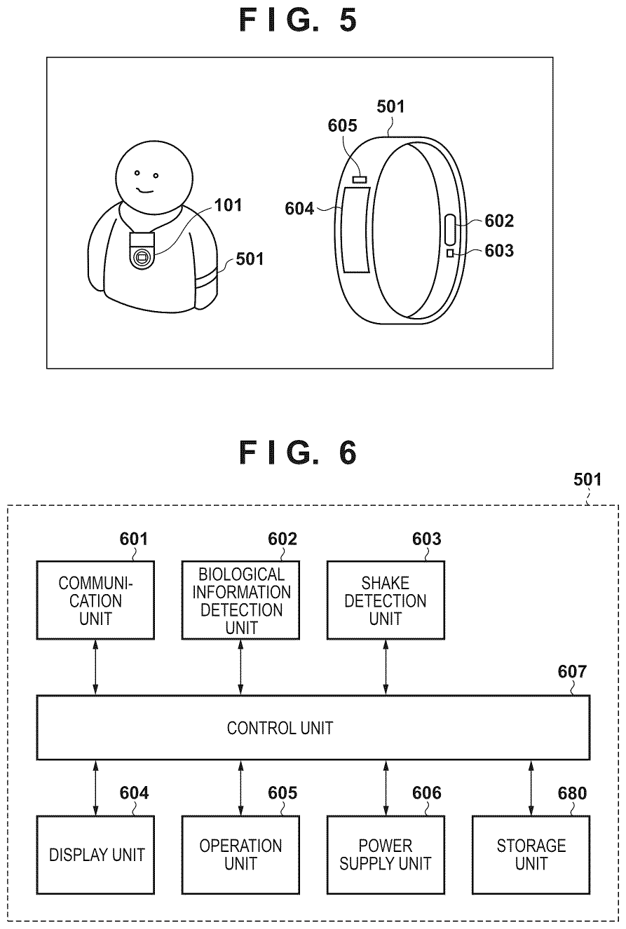

FIG. 5 is a view schematically exemplifying the outer appearances of an external apparatus 501 capable of communicating with the camera 101.

The camera 101 according to the present embodiment is a wearable camera that can be attached to, for example, the neck of the user. The external apparatus 501 according to the present embodiment is a wearable device that can be attached to, for example, an arm of the user. The external apparatus 501 according to the present embodiment is an information processing apparatus that includes sensors configured to detect the biological information and the exercise state of the user and can communicate with the camera 101 by a Bluetooth® communication module or the like.

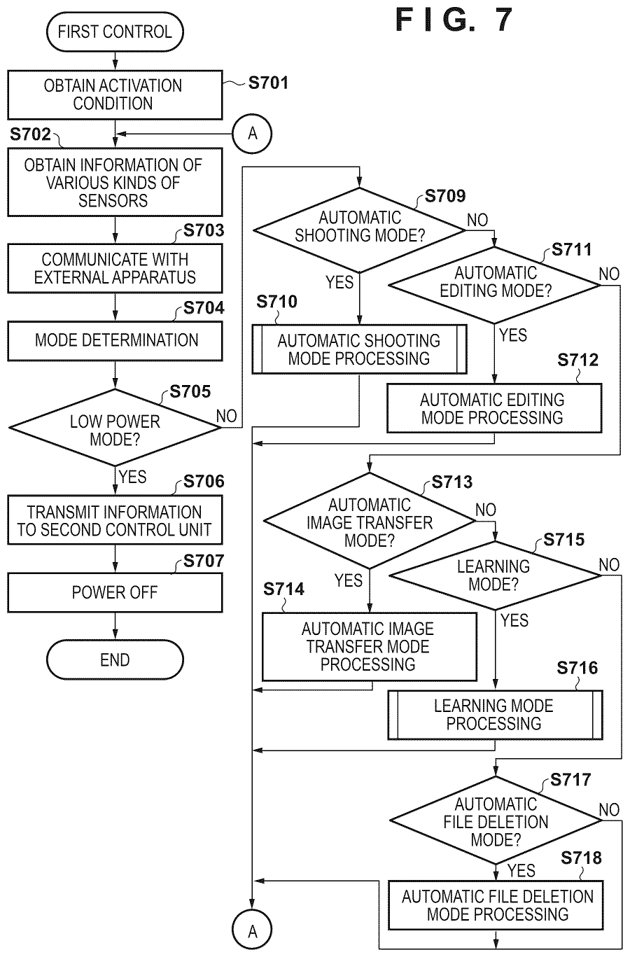

The external apparatus 501 includes a biological information detection unit 602. The biological information detection unit 602 includes a pulse senor, a heart rate sensor, and a blood flow sensor, which detect the pulse, heart rate, and blood flow of the user, respectively, and a sensor that detects a potential change by skin contact using a conductive polymer. In the present embodiment, an example in which the biological information detection unit 602 is a heart rate sensor will be described. The heart rate sensor irradiates a skin with infrared light using, for example, an LED and processes the detection signal of the sensor that receives the infrared light transmitted through a body tissue, thereby detecting the heart rate of the user. The biological information detection unit 602 outputs the detected biological information to a control unit 607 (see FIG. 6).

The external apparatus 501 includes a shake detection unit 603. The shake detection unit 603 detects the exercise state of the user. The shake detection unit 603 includes, for example, an acceleration sensor or a gyro sensor, and obtains the moving information and motion detection information of the user. The moving information is information indicating, based on acceleration information, whether the user is moving or a moving speed or the like. The motion detection information is information indicating that the user is making a motion such as “waving arms around”.

The external apparatus 501 includes a display unit 604 and an operation unit 605. The display unit 604 includes a display device such as an LCD or an LED, and outputs visible information. The operation unit 605 accepts a user's operation instruction for the external apparatus 501.

FIG. 6 is a block diagram exemplifying the internal configuration of the external apparatus 501.

The external apparatus 501 includes a control unit 607, a communication unit 601, the biological information detection unit 602, the shake detection unit 603, the display unit 604, the operation unit 605, a power supply unit 606, and a storage unit 608.

A control unit 607 includes a processor such as a CPU or an MPU for performing arithmetic processing and control processing of the external apparatus 501, and executes control programs stored in the storage unit 608, thereby controlling the components of the external apparatus 501.

The storage unit 608 is a memory that stores various kinds of information such as control programs to be executed by the control unit 607 and parameters necessary for communication. Various kinds of operations to be described later are implemented by executing the control programs stored in the storage unit 608 by the control unit 607.

The power supply unit 606 supplies power to the units of the external apparatus 501.

The operation unit 605 accepts a user's operation instruction for the external apparatus 501 and notifies the control unit 607 of it. Also, the operation unit 605 obtains information of a user's voice by a microphone incorporated in the external apparatus 501, identifies a user's operation instruction by speech recognition processing, and notifies the control unit 607 of it. The display unit 604 outputs visible information or outputs a sound like a speaker, thereby presenting various kinds of information to the user.

The control unit 607 processes detection signals obtained from the biological information detection unit 602 and the shake detection unit 603, and transmits these to the camera 101 by the communication unit 601. For example, the external apparatus 501 transmits detection information to the camera 101 at a timing at which a change of the heart rate of the user is detected. Also, the external apparatus 501 transmits detection information to the camera 101 at the timing of a change of the moving state such as walking moving, running moving, or stop. Also, the external apparatus 501 transmits detection information to the camera 101 at a timing at which a preset motion of arm waving is detected. In addition, the external apparatus 501 transmits detection information to the camera 101 at a timing at which movement by a preset distance is detected.

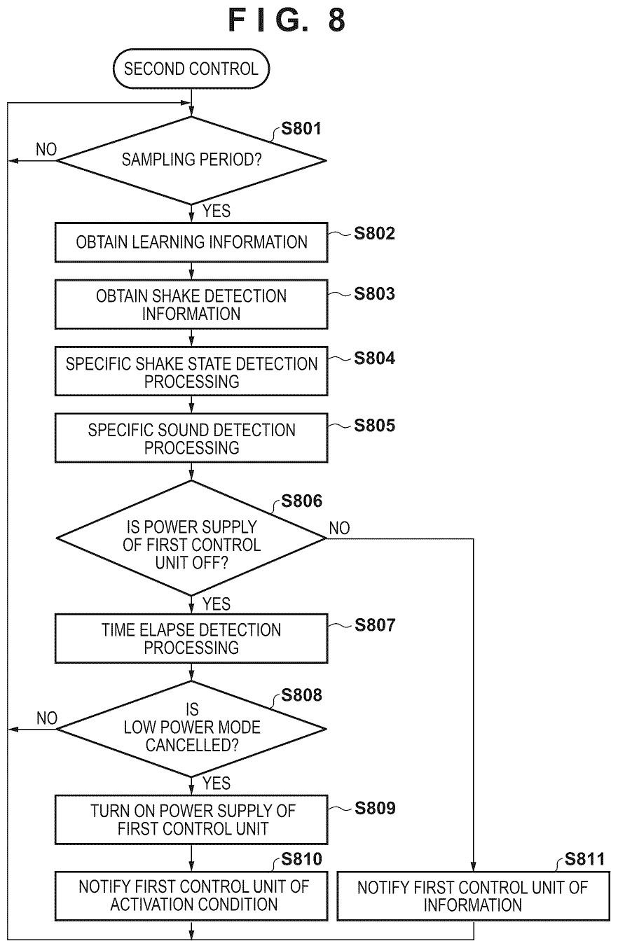

First control processing by the camera 101 will be described next with reference to FIG. 7.

FIG. 7 is a flowchart exemplifying first control processing executed by the first control unit 223 (main processor) of the camera 101.

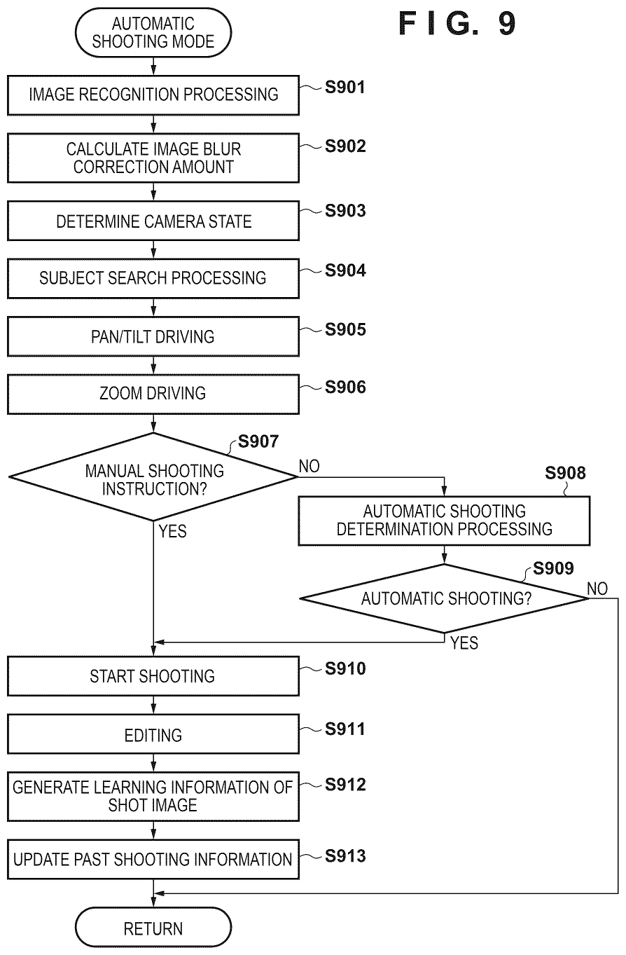

When the user operates the power button provided on the camera 101, power is supplied from the first power supply unit 210 to the first control unit 223 and the components of the camera 101. In addition, power is supplied from the second power supply unit 212 to the second control unit 211. Details of the operation of the second control unit 211 will be described later with reference to FIG. 8.

In step S701, the first control unit 223 obtains an activation condition and advances to the process of step S702. In the present embodiment, there are following activation conditions.
(1) The power supply is activated by manually pressing the power button.
(2) The power supply is activated by transmitting an activation instruction from an external apparatus (for example, the external apparatus 301) by communication (for example, BLE).
(3) The power supply is activated by an instruction from the second control unit 211.

Here, if (3) the power supply is activated by an instruction from the second control unit 211, an activation condition calculated by the second control unit 211 is used. The activation condition is used as one of parameters in subject search or automatic shooting. Details of the determination condition will be described later with reference to FIG. 8. After the process of step S701 is performed, the process advances to step S702.

In step S702, the first control unit 223 obtains detection signals of various kinds of sensors. The detection signals of various kinds of sensors are as follows.
A detection signal of a sensor configured to detect a vibration, like a gyro sensor or an acceleration sensor in the camera shake detection unit 209
A detection signal of each rotation position of the tilt unit 104 and the pan unit 105
A sound signal detected by the sound processing unit 214, a trigger signal by specific speech recognition, and a detection signal of a sound direction
A detection signal of environment information by the environment sensor 226 After the process of step S702 is performed, the process advances to step S703.

In step S703, the first control unit 223 determines whether a communication instruction is transmitted from the external apparatus, and if a communication instruction is transmitted, controls communication with the external apparatus. For example, processing of obtaining various kinds of information from the external apparatus 301 is executed. The various kinds of information include shooting control information (shooting instruction) from the external apparatus 301, such as a remote operation, a sound signal, an image signal, a compressed sound signal, or a compressed image signal by a wireless LAN or BLE, a predetermined position detection notification based on GPS information such as voice command registration data, a position moving notification, learning data, and the like. Also, if user's exercise information, arm action information, and biological information such as a heart rate, which are obtained from the external apparatus 501, need to be updated, information obtaining processing by BLE is executed. Note that an example in which the environment sensor 226 is mounted in the camera 101 has been described, but it may be mounted in the external apparatus 301 or the external apparatus 501. In this case, in step S703, environment information obtaining processing by BLE is performed. After the process of step S703 is performed, the process advances to step S704.

In step S704, the first control unit 223 determines the operation mode of the camera 101. The operation modes include “automatic shooting mode” (step S710), “automatic editing mode” (step S712), “automatic image transfer mode” (step S714), “learning mode” (step S716), and “automatic file deletion mode” (step S718).

In step S705, the first control unit 223 determines whether the operation mode determined in step S704 is a low power mode. The low power mode is a mode that is set if the operation mode is none of “automatic shooting mode”, “automatic editing mode”, “automatic image transfer mode”, “learning mode”, and “automatic file deletion mode”. Upon determining in step S705 that the operation mode is the low power mode, the process advances to step S706. Upon determining that the operation mode is not the low power mode, the process advances to step S709.

In step S706, the first control unit 223 notifies the second control unit 211 (sub processor) of various kinds of parameters associated with the activation condition determined by the second control unit 211. The various kinds of parameters include a shake detection determination parameter, a sound detection parameter, and a time elapse detection parameter. The parameter values change when learning processing to be described later is performed.

After the process of step S706 is ended, the process advances to step S707, the first control unit 223 (main processor) is powered off, and the processing is ended.

In steps S709, S711, S713, S715, and S717, the first control unit 223 determines whether the mode determined in step S704 is the automatic shooting mode, the automatic editing mode, the automatic image transfer mode, the learning mode, or the automatic file deletion mode.

In mode determination processing of step S704, one of the following modes (1) to (5) is determined.
(1) Automatic Shooting Mode

### Mode Determination Condition

The condition is that it is determined to perform automatic shooting based on pieces of detection information set in learning data, time elapsed from transition to the automatic shooting mode, past shooting information, and information such as the number of shot images. The pieces of information are information such as image, sound, time, vibration, position, bodily change, and environmental change.

### Processing in Mode

Upon determining in step S709 that the mode is the automatic shooting mode, the process advances to automatic shooting mode processing (step S710). Pan, tilt, and zoom driving operations are performed based on the detection information set in the learning data, and automatic subject search is executed. Upon determining that it is a timing at which user's preferred shooting can be performed, shooting is performed automatically.
(2) Automatic Editing Mode

### Mode Determination Condition

The condition is that it is determined to perform automatic editing based on time elapsed from the preceding timing of automatic editing and past shot image information.

### Processing in Mode

Upon determining in step S711 that the mode is the automatic editing mode, the process advances to automatic editing mode processing (step S712). Processing of selecting still images or moving images based on learning is performed, and automatic editing processing of generating a highlight moving image by putting these into one moving image based on learning considering the image effect or the time of the moving image after editing is performed.
(3) Automatic Image Transfer Mode
   Mode Determination Condition The condition is that, if the automatic image transfer mode is set by an instruction from a dedicated application of the external apparatus 301, it is determined to perform automatic transfer based on time elapsed from the preceding timing of image transfer and past shot image information.

### Processing in Mode

Upon determining in step S713 that the mode is the automatic image transfer mode, the process advances to automatic image transfer mode processing (step S714). The camera 101 automatically extracts a user's preferred image and automatically transfers the extracted image to the external apparatus 301. Extraction of the user's preferred image is performed based on a score (to be described later) that is added to each image to determine the user's preference.
(4) Learning Mode

### Mode Determination Condition

The condition is that it is determined to perform automatic learning based on time elapsed from the preceding timing of learning processing, information integrated with images usable in learning, and the number of learning data. Alternatively, the learning mode is set even in a case where an instruction to set the learning mode is received by communication with the external apparatus 301.

### Processing in Mode

Upon determining in step S715 that the mode is the learning mode, the process advances to learning mode processing (step S716). In the learning mode, pieces of operation information on the external apparatus 301, a notification of learning information from the external apparatus 301, and the like are input, and learning processing according to the user's preference is performed using a learning mode such as a neural network (to be referred to as an NN hereinafter). In the present embodiment, the learning processing is machine learning using an NN such as deep learning, and the NN is a Convolutional Neural Network (CNN). The pieces of operation information include image obtaining information from the camera, information manually edited by a dedicated application, determination information input by the user for the image of the camera, and the like. Learning processing associated with detection, such as personal authentication registration, voice registration, sound scene registration, and registration of generation object recognition and learning processing of the above-described low power mode condition are also performed simultaneously.
(5) Automatic File Deletion Mode
   Mode Determination Condition The condition is that it is determined to perform automatic file deletion based on time elapsed from the preceding timing of automatic file deletion and the remaining capacity of the nonvolatile memory 216 in which image data is recorded.
   Processing in Mode Upon determining in step S717 that the mode is the automatic file deletion mode, the process advances to automatic file deletion mode processing (step S718). Processing of designating a file to be automatically deleted from images in the nonvolatile memory 216 based on the tag information of each image and the date/time of shooting and deleting the file is executed.

When the process of step S710, S712, S714, S716, or S718 in FIG. 7 is ended, the process returns to step S702 to continue the processing. Details of the automatic shooting mode processing in step S710 and the learning mode processing in step S716 will be described later.

When it is determined in step S709 of FIG. 7 that the mode is not the automatic shooting mode, the process advances to step S711. When it is determined in step S711 that the mode is not the automatic editing mode, the process advances to step S713. When it is determined in step S713 that the mode is not the automatic image transfer mode, the process advances to step S715. When it is determined in step S715 that the mode is not the learning mode, the process advances to step S717. When it is determined in step S717 that the mode is not the automatic file deletion mode, the process returns to step S702 to repeat the processing. Note that a detailed description of the automatic editing mode, the automatic image transfer mode, and the automatic file deletion mode will be omitted.

Second control processing by the camera 101 will be described next with reference to FIG. 8.

FIG. 8 is a flowchart exemplifying second control processing executed by the second control unit 211 (sub processor) of the camera 101.

When the user operates the power button provided on the camera 101, power is supplied from the first power supply unit 210 to the first control unit 223 and the components of the camera 101. In addition, power is supplied from the second power supply unit 212 to the second control unit 211.

When power is supplied, the second control unit 211 is activated, and processing shown in FIG. 8 is started.

In step S801, the second control unit 211 waits until a predetermined sampling period elapses, and when the predetermined sampling period elapses, the process advances to step S802. The predetermined sampling period is set to a period of, for example, 10 msec.

In step S802, the second control unit 211 obtains learning information. The learning information is information transmitted from the first control unit 223 to the second control unit 211 in step S706 of FIG. 7, and includes, for example, the following information used for determination.
(1) Determination information of specific shake state detection (step S804)
(2) Determination information of specific sound detection (step S805)
(3) Determination information of time elapse detection (step S807) In step S803, the second control unit 211 obtains shake detection information. The shake detection information is the detection signal of the gyro sensor or the acceleration sensor in the camera shake detection unit 209.

In step S804, the second control unit 211 detects a specific shake state that is set in advance. Some examples in which determination processing is changed in accordance with the learning information obtained in step S802 will be described here.

### Tap Detection

A tap state is a state in which, for example, the user taps the camera 101 with a fingertip or the like, and can be detected from the output value of an acceleration sensor attached to the camera 101. An output from a triaxial acceleration sensor is processed at the predetermined sampling period through a bandpass filter (BPF) set to a specific frequency region, and a component in the signal region of an acceleration change by the tap is extracted. The number of times the acceleration signal after passing through the bandpass filter (BPF) exceeds a predetermined threshold ThreshA during a predetermined time TimeA is measured. Tap determination is performed based on whether the measured count is a predetermined count CountA. For example, in a case of double tap, the value of the predetermined count CountA is set to 2, and in a case of triple tap, the value of the predetermined count CountA is set to 3. Even the values of the predetermined time TimeA and the predetermined threshold ThreshA can be changed in accordance with the learning information.

### Shake State Detection

The shake state of the camera 101 can be detected from the output value of the gyro sensor or the acceleration sensor attached to the camera 101. As for the output from the gyro sensor or the acceleration sensor, the high frequency component is cut by a high-pass filter (HPF), the low frequency component is cut by a low-pass filter (LPF), and absolute value conversion is then performed. The number of times the calculated absolute value exceeds a predetermined threshold ThreshB during a predetermined time TimeB is measured. Vibration determination is performed based on whether the measured count is a predetermined count CountB or more. For example, it is possible to determine whether the camera 101 is placed on a desk or the like, that is, the shake is small or whether the user is walking with the camera 101 attached as a wearable camera to the body, that is, the shake is large. Also, concerning the condition of the determination threshold or the count of determination, when a plurality of conditions are set, a specific shake state according to a shake level can be detected. The values of the predetermined time TimeB, the predetermined threshold ThreshB, and the predetermined count CountB can be changed in accordance with the learning information.

In the above-described example, a method of detecting a specific shake state by determining the detection value of the shake detection sensor has been described. There is also a method of detecting a specific shake state registered in advance using a learning model that has learned data of a shake detection sensor, which is obtained at the predetermined sampling period and input to a shake state determiner using an NN. In this case, in step S802 (learning information obtaining), only obtaining of the weight coefficient of the NN is performed.

In step S805, the second control unit 211 performs processing of detecting a preset specific sound. In the present embodiment, some examples in which detection processing is changed in accordance with the learning information obtained in step S802 will be described.

### Specific Voice Command Detection

In processing of detecting a specific voice command, specific voice commands include some commands registered in advance and commands based on specific voices that the user registers in the camera.

### Specific Sound Scene Recognition

A sound scene is determined by a network that has performed machine learning in advance based on an enormous amount of sound data. For example, it is possible to detect a specific scene such as “they are cheering”, “they are clapping”, or “they are speaking out”. The detection target scene changes by learning.

### Sound Level Determination

It is determined whether the sound volume exceeds a predetermined volume (threshold) during a predetermined time (threshold time), thereby detecting the sound level. The threshold time or the threshold changes by learning.

### Sound Direction Determination

For a sound of a predetermined volume, the direction of the sound is detected by a plurality of microphones arranged on a plane.

The sound processing unit 214 performs the above-described determination processing, and by settings learned in advance, the second control unit 211 determines whether a specific sound is detected in step S805.

In step S806, the second control unit 211 determines whether the power supply of the first control unit 223 is off. Upon determining that the first control unit 223 is off, the process advances to step S807. Upon determining that the first control unit 223 is on, the process advances to step S811.

In step S807, the second control unit 211 performs processing of detecting the elapse of a preset time. In the present embodiment, the detection processing is changed by the learning information obtained in step S802. The learning information is information transmitted from the first control unit 223 to the second control unit 211 in step S706 of FIG. 7. Here, the time elapsed from the timing of transition of the power supply of the first control unit 223 from the on state to the off state is measured. When the elapsed time is equal to or more than a predetermined time TimeC, it is determined that a predetermined time has elapsed. When the elapsed time is less than the predetermined time TimeC, it is determined that the predetermined time has not elapsed. The predetermined time TimeC is a parameter that changes by the learning information.

In step S808, the second control unit 211 determines whether a condition to cancel the low power mode is satisfied. Whether to cancel the low power mode is determined based on the following conditions.
(1) A specific shake is detected.
(2) A specific sound is detected.
(3) A predetermined time has elapsed.

In (1), it is determined, in step S804 (specific shake state detection processing), whether a specific shake is detected. In (2), it is determined, in step S805 (specific sound detection processing), whether a specific sound is detected. In (3), it is determined, in step S807 (time elapse detection processing), whether a predetermined time has elapsed. When at least one of the conditions (1) to (3) is satisfied, it is determined that the condition to cancel the low power mode is satisfied. Upon determining in step S808 that the condition to cancel the low power mode is satisfied, the process advances to step S809. Upon determining that the condition to cancel the low power mode is not satisfied, the process returns to step S801 to continue the processing.

In step S809, the second control unit 211 powers on the first control unit 223.

In step S810, the second control unit 211 notifies the first control unit 223 of the condition (one of a shake, sound, and time) determined to cancel the low power mode and then returns to step S801 to continue the processing.

On the other hand, when transiting from step S806 to S811 (when it is determined that the power supply of the first control unit 223 is on), the process advances to step S811.

In step S811, the second control unit 211 notifies the first control unit 223 of the detection information obtained in steps S803 to S805 and then returns to step S801 to continue the processing.

In the present embodiment, even if the power supply of the first control unit 223 is on, the second control unit 211 detects a shake or specific sound and notifies the first control unit 223 of the detection result. However, the present disclosure is not limited to this example. When the power supply of the first control unit 223 is on, specific shake detection or specific sound detection may be performed by the processing (step S702 of FIG. 7) of the first control unit 223 without performing the processes of steps S803 to S805.

As described above, by performing steps S704 to S707 of FIG. 7 or the processing shown in FIG. 8, the condition to shift to the low power mode or the condition to cancel the low power mode is learned based on a user operation. That is, it is possible to operate the camera in accordance with the convenience of the user who owns the camera 101. The learning method will be described later.

In the example shown in FIG. 8, a method of canceling the low power mode based on shake detection, sound detection, and time elapse has been described. However, the low power mode may be canceled based on environment information. As the environment information, cancel determination can be performed based on whether the absolute amount or change amount of the temperature, atmospheric pressure, illuminance, humidity, or ultraviolet radiation amount exceeds a predetermined threshold, and the threshold can be changed by learning (to be described later). Also, detection information of shake detection, sound detection, and time elapse or the absolute value or change amount of each environment information may be determined by learning processing, and determination to cancel the low power mode may be performed. In the determination processing, the determination condition can be changed by learning processing to be described later.

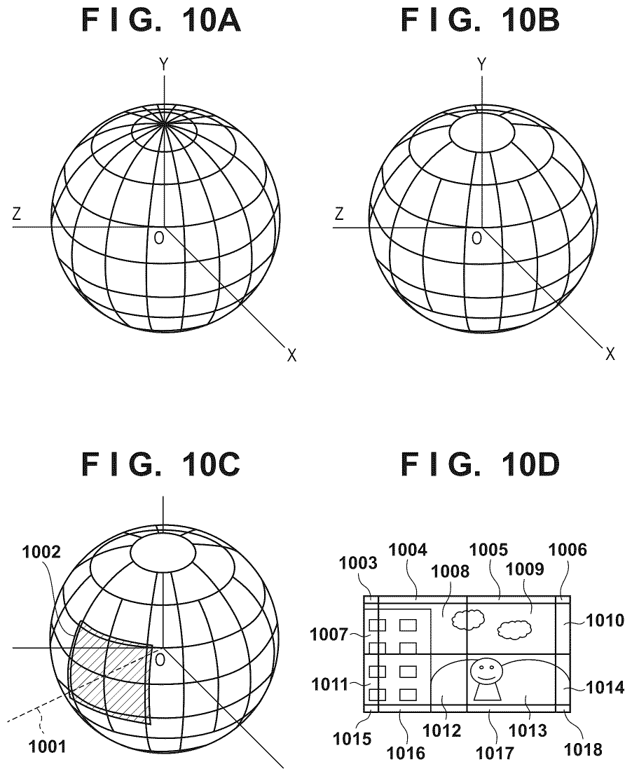

Automatic shooting mode processing in step S710 of FIG. 7 will be described next with reference to FIG. 9.

In step S901, the first control unit 223 performs, by the image processing unit 207, image processing for an image signal generated by the image sensor 206, thereby generating image data for subject detection. In addition, the image processing unit 207 performs subject recognition processing of detecting a person or a general object from the generated image data.

When detecting a person who is a subject, the face or body of the subject is detected. In face detection processing, a portion that matches a predetermined pattern for determining a person face can be detected as a person face region for the image data. Simultaneously, reliability indicating the likelihood as the face of the subject is calculated. The reliability is calculated from, for example, the size of the face region in the image data or a matching degree indicating the degree of matching to a face pattern. The processing is similarly performed even for general object recognition, and an object that matches a pattern registered in advance can be detected.

There is also a method of extracting the feature information of a subject using a histogram of the hue or chroma of image data. As for the image of a subject in the angle of view, a distribution derived from the histogram of the hue or chroma is divided into a plurality of sections, and processing of classifying an image is executed for each section. For example, the histogram of a plurality of color components is generated for the image, and divided based on the distribution range of the histogram. In a region belonging to the combination of the same section, the image is classified, and the image region of the subject is recognized. An evaluation value is calculated for each image region of the recognized subject, thereby determining the image region of the subject having the highest evaluation value as a main subject region. By the above-described method, the feature information of various kinds of subjects can be obtained from the image.

In step S902, the first control unit 223 calculates an image blur correction amount. As the image blur correction amount, the absolute angle of the shake of the camera is calculated based on the information of the angular velocity and the acceleration detected by the camera shake detection unit 209, and an angle to correct an image blur by tilt/pan-driving in an angle direction for canceling the absolute angle is calculated. Note that for the image blur correction amount calculation processing, the calculation method can be changed by learning processing to be described later.

In step S903, the first control unit 223 determines the state of the camera. Based on the angle or moving amount of the camera detected from angular velocity information, acceleration information, and GPS information, the first control unit 223 determines what kind of vibration/motion the camera currently is making. For example, assume a case where shooting is performed by the camera 101 attached to a vehicle. In this case, subject information such as the scenery around the vehicle largely changes in accordance with the moving distance of the vehicle. For this reason, it is determined whether the state is a “vehicle moving state” in which the vehicle to which the camera 101 is attached is moving at a high speed, and the determination result is used for subject search processing to be described later. In addition, it is determined whether the change of the angle of the camera 101 is large. It is determined whether the state is a “fixed-camera shooting state” with little shake of the camera 101. When the state is the “fixed-camera shooting state”, it can be determined that there is no position change of the camera 101. In this case, subject search processing for fixed-camera shooting can be performed. Also, when the angle change of the camera 101 is relatively large, it is determined that the state is a handheld state″. In this case, subject search processing for handheld shooting can be performed.

In step S904, the first control unit 223 performs subject search processing. The subject search includes the following processes.
(1) Area division
(2) Calculation of degree of importance for each area
(3) Determination of search target area The processes (1) to (3) will sequentially be described below.
(1) Area division

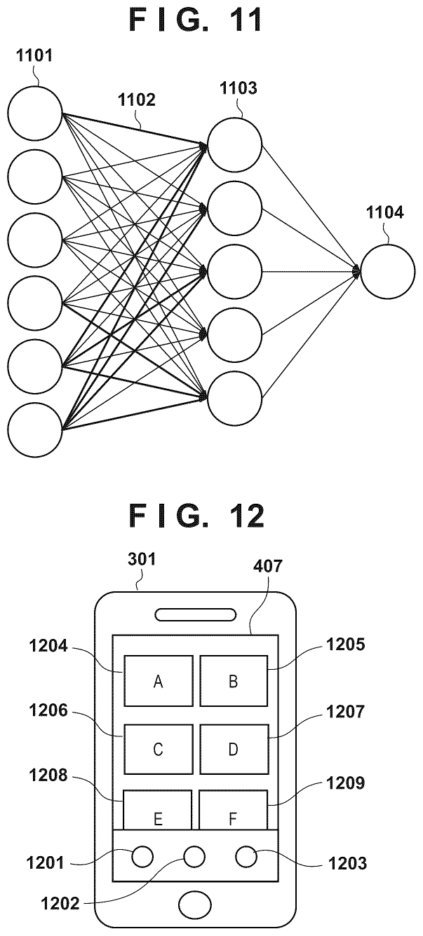

Area division will be described with reference to FIGS. 10A to 10D. An origin O of three-dimensional orthogonal coordinates is set to a camera position. FIG. 10A is a schematic view showing an example in which a spherical omnidirectional shooting range with respect to the camera position (origin O) as the center are divided into areas. In the example shown in FIG. 10A, the omnidirectional shooting range is divided into 22.5° areas in the tilt direction and the pan direction. In this area division, as the tilt angle is separated from 0°, the circumference in the horizontal direction becomes small, and the area size becomes small. FIG. 10B shows an example in which when the tilt angle is 45° or more, area division in the horizontal direction is set larger than 22.5°. FIGS. 10C and 10D exemplify regions obtained by area division in the angle of view. An axis 1001 shown in FIG. 10C indicates the optical axis direction (shooting direction) of the camera 101, and area division is performed while defining the direction of the axis 1001 as the reference direction. An area 1002 indicates the angle of view (shooting range) of the image, and FIG. 10D exemplifies an image corresponding to the area 1002. As shown in FIG. 10D, the image in the area 1002 is divided into a plurality of areas 1003 to 1018.
(2) Calculation of Degree of Importance for Each Area

For each divided area, a degree of importance indicating a priority order of a search is calculated in accordance with the situation of a subject existing in the area and the situation of the scene. The degree of importance based on the situation of the subject is calculated based on, for example, the number of persons existing in the area, the size of the face of each person, the direction of the face, likelihood of face detection, the expression of each person, the personal authentication result of each person, and the like. Also, the degree of importance based on the situation of the scene is calculated based on, for example, a general object recognition result, a scene discrimination result (blue sky, backlight, evening), a sound level or a speech recognition result detected from the direction of the area, motion information in the area, and the like.

Also, when a vibration of the camera is detected in step S903 of FIG. 9, a setting may be done such that the degree of importance is changed in accordance with the vibration state. For example, assume a case where the state is determined as the “fixed-camera shooting state”. In this case, determination is done such that the subject search is performed with focus on a subject with a high priority (for example, the owner of the camera) among subjects registered by face authentication. Also, even for automatic shooting to be described later, shooting is performed with priority on, for example, the face of the owner of the camera. Thus, even if the time in which the owner of the camera performs shooting while carrying the camera attached to him/her is long, many images can be recorded by shooting the owner with the camera detached and placed on, for example, a desk. In this case, it is possible to search for a face by pan and tilt driving. For this reason, the owner can obtain many images of himself/herself or many images of the face only by properly installing the camera without considering the angle of the camera.

Note that only with the above-described conditions, the same area may always have the highest degree of importance unless there is a change in each area. In that case, the area to search for remains the same for a long time. Hence, processing of changing the degree of importance in accordance with past shooting information is performed. More specifically, processing of lowering the degree of importance of an area that continuously designated, for a predetermined time, as the search target or processing of lowering the degree of importance of an area shot in step S910 to be described later for a predetermined time is performed.
(3) Determination of Search Target Area

Based on the thus calculated degree of importance of each area, processing of determining an area of a high degree of importance as a search target area is executed. Then, target angles of pan and tilt necessary for fitting the search target area in the angle of view are calculated.

Referring back to FIG. 9, in step S905, the first control unit 223 performs pan and tilt driving. The first control unit 223 adds the image blur correction amount and the angles based on the target angles of pan and tilt at a predetermined sampling period, thereby calculating a pan driving amount and a tilt driving amount. The pan/tilt drive control unit 205 drives and controls the tilt unit 104 and the pan unit 105 based on the pan driving amount and the tilt driving amount.

In step S906, the first control unit 223 performs zoom driving by controlling the zoom unit 201. The first control unit 223 performs zoom driving in accordance with the state of the search target subject determined in step S904. For example, assume a case where the search target subject is a person face. In this case, if the face size in an image is too small, it cannot be detected because the size is less than the minimum detectable size, and sight of the subject may be lost. In such a case, zoom control to the telephoto side is performed, thereby controlling to make the face size in the image large. On the other hand, if the face size in the image is too large, the subject may be off the angle of view due to the motion of the subject or the camera itself. In such a case, zoom control to the wide-angle side is performed, thereby controlling to make the face size in the image small. When the zoom control is thus performed, a state suitable to track the subject can be held. Note that as the zoom control, there are optical zoom control performed by lens driving and electronic zoom control that changes the angle of view by image processing. Also, there are a method of performing one of the control methods and a method that combines both control methods.

In step S907, the first control unit 223 determines whether a manual shooting instruction by the user is received. Manual shooting instructions are an instruction by pressing a shutter button, an instruction by lightly tapping the camera housing with a finger or the like, an instruction by inputting a voice command, and an instruction from an external apparatus. For example, a shooting instruction using tap as a trigger is determined by detecting a continuous high-frequency acceleration in a short period by the camera shake detection unit 209 when the user taps the housing of the camera. Also, as a shooting instruction method by a voice command, if the user utters a predetermined password (for example, “take a photo”) that instructs shooting, the sound processing unit 214 recognizes the voice and uses it as a trigger to start shooting. As an instruction method from an external apparatus, for example, a shooting instruction transmitted from a dedicated application of a smartphone wirelessly connected to the camera is used as the trigger.

Upon receiving a manual shooting instruction in step S907, the process advances to step S910. When it is determined in step S907 that no manual shooting instruction is received, the process advances to step S908.

In step S908, the first control unit 223 performs automatic shooting determination processing. In the automatic shooting determination processing, it is determined whether to perform automatic shooting, and the shooting method is determined (it is determined which one of still image shooting, moving image shooting, sequential shooting, and panoramic shooting should be executed).

Automatic shooting is processing of automatically recording image data generated by the image sensor 206. As for determining whether to perform automatic shooting, it is determined to perform automatic shooting in the first case and the second case below. The first case is a case where the degree of importance exceeds a predetermined value based on the degree of importance of each area obtained in step S904. The second case is a case where a determination result by an NN is applied, and the second case will be described later. Note that recording of automatically shot images includes recording image data in the working memory 215, recording image data in the nonvolatile memory 216, and automatically transferring image data to the external apparatus 301 and recording the image data in the external apparatus 301.

In the present embodiment, by the automatic shooting determination processing using an NN, the camera 101 automatically performs shooting. It is sometimes preferable to change the parameters of the automatic shooting determination processing depending on the situation of the shooting position or the situation of the camera. Unlike shooting at a predetermined time interval, for automatic shooting according to the situation of the camera, there is a tendency to prefer the following forms meeting a user's shooting intention.

1(1) The user wants to shoot a lot of images including persons and things.
(2) The user does not want to miss to take a memorable scene.
(3) The user wants to shoot while saving power consideration of the remaining battery level and the remaining capacity of the recording medium.

Automatic shooting is executed when an evaluation value is calculated from the state of the subject, the evaluation value is compared with a threshold, and the evaluation value exceeds the threshold. The evaluation value of automatic shooting is determined by determination processing using an NN.

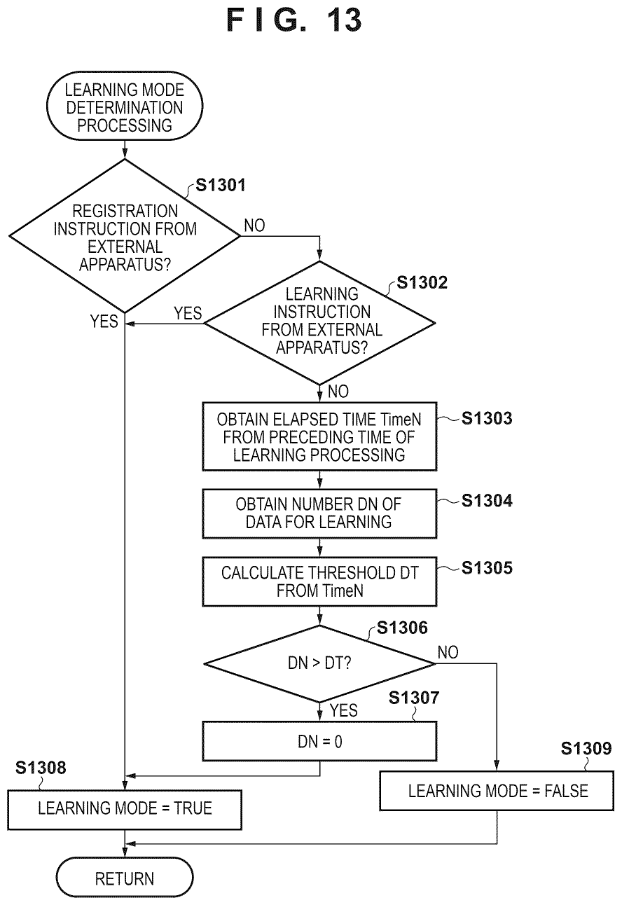

FIG. 11 exemplifies the configuration of a neural network by multilayer perceptron. The NN is used to predict an output value from an input value. When an input value and an output value that is a model to the input value are learned in advance, an output value according to the model learned by the NN can be estimated for a new input value. Note that the learning method will be described later.

In FIG. 11, a node 1101 and a plurality of nodes vertically arranged and represented by circles indicate the neurons of an input layer. A node 1103 and a plurality of nodes vertically arranged and represented by circles indicate the neurons of an intermediate layer. A node 1104 indicates the neuron of an output layer. An arrow 1102 indicates connection between the neurons. By determination processing using the NN, feature amounts based on a subject in the current angle of view and the states of the scene and the camera are given as inputs to the neurons of the input layer. An operation based on the forward propagation rule of multilayer perceptron is performed, thereby obtaining a value output from the output layer. When the output value is equal to or larger than a threshold, it is determined to execute automatic shooting.

As the feature amounts of a subject, for example, the following pieces of information are used.
The recognition result of a general object at the current zoom magnification and the current angle of view
A face detection result, the number of faces in the current angle of view, a smiling level, an eye closing level, a face angle, a face authentication ID number, and the sight line angle of a person
A scene discrimination result, time elapsed from preceding shooting, current time, GPS information, and a change amount from the preceding shooting position
A current sound level, a person who is uttering a voice, and information representing whether there is clapping or cheering
Vibration information (acceleration information and a camera state), and environment information (temperature, atmospheric pressure, illuminance, humidity, and ultraviolet radiation amount)

Furthermore, when an information notification is received from the external apparatus 501 or the like, the notified information (exercise information of the user, arm action information, and biological information such as a heart rate) is also used as feature information. Each feature information is converted into a numerical value within a predetermined range and given as a feature amount to each neuron of the input layer. Hence, the input layer needs to have neurons as many as the feature amounts used.

In automatic shooting determination by the NN, the output value can be changed by changing a weight coefficient for adjusting the connection relationship between neurons by learning processing to be described later, and the determination result can be adapted to the learning result.

Also, the automatic shooting determination changes depending on the activation condition of the first control unit 223 obtained in step S702 of FIG. 7. For example, in a case of activation by tap detection or activation by a specific voice command, since there is high possibility that as the user's intention, it is an operation of instructing shooting at that point, the activation condition is set such that the shooting frequency is high.

When determining the shooting method, automatic shooting is determined based on the state of the camera 101 and the state of a subject on the periphery, which are detected in steps S901 to S904, and it is determined which one of, for example, still image shooting, moving image shooting, sequential shooting, and panoramic shooting should be executed. For example, when a person who is a subject stands still, still image shooting is selected and executed. When the subject is moving, moving image shooting or sequential shooting is executed. When a plurality of subjects exist surrounding the camera or it is determined based on GPS information that the site is a scenic spot, panoramic shooting processing is executed. Panoramic shooting processing is processing of compositing images sequentially shot while performing pan and tilt driving and generating a panoramic image. Note that like the automatic shooting determination method, determination may be performed by inputting various kinds of information detected before shooting to the NN, and the shooting method may thus be determined. Also, in the determination using the NN, the determination condition can be changed by learning processing to be described later.

Referring back to FIG. 9, upon determining to perform automatic shooting in step S909, the process advances to step S910. Upon determining not to perform automatic shooting in step S909, the shooting mode processing is ended.

In step S910, the first control unit 223 starts automatic shooting. The first control unit 223 starts shooting by the shooting method determined in step S908. In this case, the focus drive control unit 204 performs auto focus control. Also, exposure control is performed using an aperture control unit, a sensor gain control unit, and a shutter control unit (none are shown), thereby adjusting the subject to an appropriate brightness. The image processing unit 207 performs various kinds of known image processing such as auto white balance processing, noise reduction processing, and gamma correction processing for the captured image, thereby generating image data.

When a predetermined condition is satisfied at the time of automatic shooting in step S910, the camera 101 may perform shooting after notifying the person who is the shooting target that shooting is to be performed. The predetermined condition is set based on, for example, the following information.

The number of faces in the angle of view, the smiling level of each face, an eye closing level, the sight line angle or face angle of a person, and a face authentication ID number
The number of persons registered by personal authentication, and the recognition result of a general object in shooting
A scene discrimination result, time elapsed from preceding shooting, shooting time, information indicating, based on GPS information, whether the current position is a scenic spot
A sound level in shooting, the presence/absence of a person who is uttering a voice, and information representing whether there is clapping or cheering
Vibration information (acceleration information and a camera state), and environment information (temperature, atmospheric pressure, illuminance, humidity, and ultraviolet radiation amount)

As the notification method, for example, sound generation from the sound output unit 218 or LED lighting by the light emission control unit 224 is used. When shooting with a notification is performed based on these conditions, an image with a preferred line of sight toward the camera can be recorded in an important scene. Even for a notification before shooting, determination can be performed by inputting information of a shot image or various kinds of information detected before shooting to the NN, and the notification method or timing can thus be determined. Also, in the determination processing, the determination condition can be changed by learning processing to be described later.

In step S911, the first control unit 223 performs, by the image processing unit 207, editing processing of processing the image data generated in step S910 or adding it to a moving image. Image processing includes trimming processing based on the face of a person or an in-focus position, image rotation processing, a high dynamic range (HDR) effect, a blur effect, and a color conversion filter effect. In the image processing, a plurality of image data may be generated from the image data generated in step S910 by combining the above-described editing processes and stored separately from the shot image. Also, as for moving image processing, processing of adding a shot moving image or still image to a generated editing moving image may be performed while applying special effect processing such as sliding, zoom, or fading. Even for editing processing in step S911, the image processing method can be determined by inputting information of a shot image or various kinds of information detected before shooting to the NN. Also, in the determination processing, the determination condition can be changed by learning processing to be described later.

In step S912, the first control unit 223 generates learning data to be used for learning processing to be described later from the image data generated in step S910 and records it. As the learning data, for example, the following pieces of information can be used.
A zoom magnification in shooting in the current shot image, a general object recognition result in shooting, a face detection result, the number of faces in the shot image, the smiling level of each face, an eye closing level, a face angle, a face authentication ID number, and the sight line angle of a person
A scene discrimination result, time elapsed from preceding shooting, shooting time, GPS information, and a change amount from preceding shooting position
A sound level in shooting, a person who is uttering a voice, and information representing whether there is clapping or cheering
Vibration information (acceleration information and a camera state), and environment information (temperature, atmospheric pressure, illuminance, humidity, and ultraviolet radiation amount)
Moving image shooting time, and information representing whether shooting is performed in accordance with a manual shooting instruction

Furthermore, a score that is the output of the NN obtained by numerically expressing a user's preferred image is calculated. Processing of generating these pieces of information and recording these as tag information in the shot image file is executed. Alternatively, the information is stored in the nonvolatile memory 216, or pieces of information of shot images are listed and stored as so-called catalog data in the recording medium 221.

In step S913, the first control unit 223 updates the past shooting information. The first control unit 223 performs updating processing of updating the number of shot images for each area in step S908, the number of shot images for each person registered by personal authentication, the number of shot images for each subject detected by general object recognition, and the number of shot images for each scene of scene discrimination. At the same time as performing processing of incrementing the number of images shot this time, the first control unit 223 stores the current shooting time and the evaluation value of automatic shooting, and holds these as shooting history information. After the process of step S913 is performed, the processing shown in FIG. 9 is ended.

Learning processing according to the user's preference will be described next.

In the present embodiment, the learning processing unit 219 performs learning processing according to the user's preference by machine learning using the learning model of the neural network shown in FIG. 11. The NN is used for inference processing of estimating an output value from an input value, and can estimate an output value corresponding to a new input value by learning the actual value of an input value and the actual value of an output value in advance. When the NN is used, for the above-described automatic shooting, automatic editing, and subject search, the operation can be learned in accordance with the user's preference. In addition, registration of subject information (a result of face authentication or a general object) that also serves as feature data to be input to the NN, shooting notification control, low power mode control, and automatic file deletion are changed by the learning processing.

Operations to which learning processing is applied in the present embodiment will be exemplified below.
(1) Automatic shooting
(2) Automatic editing
(3) Subject search
(4) Subject registration
(5) Shooting notification control
(6) Low power mode control
(7) Automatic file deletion
(8) Image blur correction
(9) Automatic image transfer

Of the operations to which learning processing is applied, a description of (2) automatic editing, (7) automatic file deletion, and (9) automatic image transfer will be omitted.

### Automatic Shooting

Learning processing for automatic shooting will be described. In automatic shooting, learning processing for automatically shooting a user's preferred image is performed. After shooting in step S910 of FIG. 9, learning information generation processing (step S912) is performed. This is processing of selecting an image for learning by a method to be described later and changing the weight coefficient of the NN based on learning information included in the image, thereby performing learning. The learning processing is performed by changing the NN that determines the automatic shooting timing and changing the NN that determines the shooting method (still image shooting, moving image shooting, sequential shooting, and panoramic shooting).

### Subject Search

Learning processing for subject search will be described. In subject search, learning processing for automatically searching for a user's preferred image is performed. In subject search processing (step S904) shown in FIG. 9, the degree of importance of each area is calculated, and a subject search is performed by pan, tilt, and zoom driving. Learning processing is performed based on a shot image or detection information during the search, and the learning result is reflected by changing the weight coefficient of the NN. When various kinds of detection information during the search operation are input to the NN, and the degree of importance is determined, a subject search can be performed while reflecting the learning result. Other than the calculation of the degree of importance, control of the search method (the speed and the moving frequency) by pan and tilt driving is performed.

### Subject Registration

Learning processing for subject registration will be described. In subject registration, learning processing for automatically performing registration or ranking of a user's preferred image is performed. As the learning processing, for example, face authentication registration, registration of general object recognition, recognition of a gesture or a voice, and registration of scene recognition by a sound are performed. Authentication registration of persons and objects is performed, and ranking setting is done based on the count and frequency of obtaining an image, the count and frequency of performing manual shooting, and the appearance frequency of a subject during a search. Each information is registered as an input for determination by the neural network.

### Shooting Notification Control

Learning processing for shooting notification will be described. Immediately before shooting in step S910 of FIG. 9, if a predetermined condition is satisfied, shooting is performed after the camera 101 notifies the person of the shooting target that shooting is to be performed. For example, processing of visually guiding the line of sight of the subject by pan and tilt driving, or attracting attention of the subject using a speaker sound generated from the sound output unit 218 or LED light emitted by the light emission control unit 224 is executed. Immediately after the notification, it is determined, based on whether the detection information (for example, a smiling level, line-of-sight detection, and a gesture) of the subject is obtained, whether to use the detection information for learning processing, and the weight coefficient of the NN is changed, thereby performing learning processing.

Each detection information immediately before shooting is input to the NN, and it is determined whether to make a notification. As for the sound level and the sound type and timing in a case of notification sound, and light for notification, the lighting time, speed, and camera direction (pan and tilt) are determined.

### Low Power Mode Control

As described with reference to FIGS. 7 and 8, control of powering on/off the first control unit 223 (main processor) is performed. Learning processing of the low power mode cancel condition or the condition to transition to the low power mode is performed. Learning processing of the low power mode cancel condition will be described first.

### Sound Detection

A user's specific voice, a specific sound scene to be detected, or a specific sound level is manually set by, for example, communication using the dedicated application of the external apparatus 301, thereby performing learning processing. Also, a plurality of detection methods are set in the sound processing unit in advance, and an image to be learned is selected by a method to be described later. Information of preceding and succeeding sounds included in the selected image is learned, and sound determination (a specific voice command or a sound scene such as “cheering” or “clapping”) as an activation factor is set, thereby performing learning processing.

### Environment Information Detection

An environment information change that the user wants to use as an activation condition is manually set by, for example, communication using the dedicated application of the external apparatus 301, thereby performing learning processing. For example, if a specific condition such as the absolute amount or change amount a temperature, an atmospheric pressure, an illuminance, an humidity, or ultraviolet radiation is set, and the condition is satisfied, the image capture apparatus can be activated. A determination threshold based on each environment information can also be learned. When it is determined, based on the camera detection information after activation based on the environment information, that the activation condition is not satisfied, the parameter of each determination threshold is set such that an environmental change is difficult to detect.

Each parameter described above also changes depending on the remaining battery level. For example, when the remaining battery level is low, the process is hard to transition to various kinds of determination. When the remaining battery level is high, the process is easy to transition to various kinds of determination. More specifically, even when the shake state detection result or the sound scene detection result does not indicate a user's intention to activate the camera, when the remaining battery level is high, it may be determined to activate the camera.

In addition, the low power mode cancel condition can also be determined by inputting shake detection information, sound detection information, detection information of time elapse, each environment information, a remaining battery level, or the like to the NN. In this case, an image for learning processing is selected by a method to be described later, and the weight coefficient of the NN is changed based on learning information included in the image, thereby performing learning processing.

Learning processing of the condition to transition to the low power mode will be described next. In the mode determination in step S704 of FIG. 7, when it is determined that the operation mode is none of “automatic shooting mode”, “automatic editing mode”, “automatic image transfer mode”, “learning mode”, and “automatic file deletion mode”, the mode transitions to the low power mode. The determination condition of each mode also changes by learning processing.

### Automatic Shooting Mode

Automatic shooting is performed while determining the degree of importance of each area and searching for a subject by pan and tilt driving. Upon determining that there does not exist a subject that is a shooting target, the automatic shooting mode is canceled. For example, when the degrees of importance of all areas or a value obtained by adding the degrees of importance of the area is equal to or less than a predetermined threshold, the automatic shooting mode is canceled. In this case, setting is done to lower the predetermined threshold in accordance with time elapsed from the timing of transition to the automatic shooting mode. As the time elapsed from the timing of transition to the automatic shooting mode increases, it becomes easy to transition to the low power mode.

Also, low power control considering a battery usable time can be performed by changing the predetermined threshold in accordance with the remaining battery level. For example, when the remaining battery level is low, the threshold is made large to make it easy to transition to the low power mode. When the remaining battery level is high, the threshold is made small to make it difficult to transition to the low power mode. Here, based on the time elapsed from the preceding timing of transition to the automatic shooting mode and the number of shot images, the parameter (predetermined time threshold TimeC) of the low power mode cancel condition of the next time is set for the second control unit 211. The above-described threshold changes by learning processing. The shooting frequency or activation frequency is manually set by, for example, communication using the dedicated application of the external apparatus 301, thereby performing learning processing.

Also, the average value of time elapsed from the time of turning on the power button of the camera 101 to the time of turning off the power button or distribution data of each time zone may be accumulated, and the parameters may be learned. In this case, for a user for which the time elapsed from the power-on time to the power-off time is short, the time interval of restoration from the low power mode or transition to the low power mode is made short by learning processing. To the contrary, for a user for which the time elapsed from the power-on time to the power-off time is long, the time interval is made long by learning processing.

Learning processing is also performed based on detection information during a subject search. Upon determining that there are many important set subjects, the time interval of restoration from the low power mode or transition to the low power mode is made short by learning processing. To the contrary, upon determining that there are little important subjects, the time interval is made long by learning processing.

### Image Blur Correction

Learning processing for image blur correction will be described. An image blur correction amount is calculated in step S902 of FIG. 9, and pan and tilt driving based on the image blur correction amount is performed in step S905. In image blur correction, learning processing for performing correction according to the feature of the shake of the camera 101 by the user is performed. For a shot image, the direction and magnitude of a blur can be estimated using, for example, a Point Spread Function (PSF). In learning information generation in step S912 of FIG. 9, the information of the estimated direction and magnitude of the blur is added to image data.

In learning mode processing in step S716 of FIG. 7, processing of learning the weight coefficient of the NN for image blur correction for predetermined input information and output (the estimated direction and magnitude of a blur) is performed. Examples of the predetermined input information are detection information at the time of shooting (motion vector information of the image in a predetermined time before shooting, motion information of a detected subject (a person or an object), and vibration information (a gyro output, an acceleration output, and a camera state)). Furthermore, environment information (temperature, atmospheric pressure, illuminance, and humidity), sound information (sound scene determination, specific voice detection, and sound level change), time information (time elapsed from activation and time elapsed from preceding shooting), position information (GPS information and position moving amount), and the like may be added to the input.

When calculating the image blur correction amount in step S902 of FIG. 9, the above-described pieces of detection information are input to the NN, thereby estimating the magnitude of the blur at the time of shooting. When the estimated magnitude of the blur is larger than a threshold, control can be performed to, for example, increase the shutter speed. Also, when the estimated magnitude of the blur is larger than the threshold, an image blur image may be obtained. Hence, shooting may be inhibited.

In addition, since the pan and tilt driving angles are limited, image blur correction cannot be performed any more after reaching the driving end. In the present embodiment, the magnitude and direction of a blur at the time of shooting are estimated, thereby estimating the range necessary for pan and tilt driving to correct an image blur during exposure. Concerning the pan and tilt driving angles, when there is no margin in the movable range during exposure, processing of increasing the cutoff frequency of a filter for calculating the image blur correction amount and performing setting that the driving angle does not fall outside the movable range is executed. Thus can suppress a large blur. Also, when the driving angle is expected to exceed the movable range, the driving angle is changed immediately before exposure, rotation in the direction opposite to the direction in which the driving angle exceeds the movable range is performed, and exposure is then started. This makes it possible to perform shooting with a suppressed image blur while ensuring the movable range. When learning associated with image blur correction is performed in accordance with the user's feature or usage in shooting, it is possible to suppress or prevent an image blur in a shot image.

In determination of the shooting method according to the present embodiment, panning shooting determination processing may be performed. In panning shooting, shooting is performed such that no image blur occurs in a subject that is a moving body and the image moves with respect to the immobile background. In the determination processing of determining whether to perform panning shooting, the pan and tilt driving speeds for shooting a subject without any blur are estimated from the detection information before shooting, and image blur correction of the subject is performed. In this case, the above-described pieces of detection information are input to the learned NN using each detection information, thereby estimating the driving speed. When the image is divided into a plurality of blocks, and the PSF of each block is estimated, the direction and magnitude of a blur in the block in which a main subject is located are estimated. Learning processing is performed based on these pieces of information.

A background panning amount can be learned from the information of an image selected by the user. In this case, the magnitude of a blur in a block (image region) where the main subject is not located is estimated, and the user's preference can be learned based on the estimated information. When the shutter speed at the time of shooting is set based on the learned preferred background panning amount, shooting capable of obtaining a user's preferred panning shooting effect can automatically be performed.

A learning method will be described next. As the learning method, there are learning processing in the camera and learning processing in cooperation with an external apparatus. Learning processing in the camera will be described first. Learning processing in the camera according to the present embodiment is performed using the following methods.
(1) Learning Processing by Detection Information in Manual Shooting

As described with reference to FIG. 9, the camera 101 can perform automatic shooting and manual shooting. When a manual shooting instruction is received in step S907, in step S912, information indicating that the image is a manually shot image is added to the shot image. Also, when shooting is performed upon determining in step S909 that automatic shooting is on, in step S912, information indicating that the image is an automatically shot image is added to the shot image. In a case of manual shooting, there is very high possibility that the shooting was performed based on a user's preferred subject, a preferred scene, and a preferred location and time interval. Hence, learning processing is performed based on learning data such as feature data and shot image data obtained at the time of manual shooting. Also, learning processing is performed based on detection information at the time of manual shooting, concerning extraction of a feature amount in the shot image, registration of personal authentication, registration of expression of each individual, and registration of a combination of persons. In addition, based on detection information at the time of subject search, learning processing of changing, based on the detection information at the time of subject search, for example, the expression of a personally registered subject, the degree of importance of a person or object near the subject is performed.
(2) Learning Processing Based on Detection Information in Subject Search

During a subject search, it is determined what kind of person, object, or scene is captured together with a subject registered by personal authentication registration, and the time ratio the subject is simultaneously captured in the angle of view is calculated. For example, the time ratio a person A who is a subject registered by personal authentication registration and a person B who is a subject registered by personal authentication registration are simultaneously captured is calculated. When the person A and the person B are in the angle of view, various kinds of detection information are stored as learning data and used in learning processing in learning mode processing (step S716 of FIG. 7) such that the score of automatic shooting determination becomes high. In another example, the time ratio the person A who is a subject registered by personal authentication registration and “cat” that is a subject detected by general object recognition are simultaneously included in the angle of view is calculated. When the person A and “cat” are simultaneously in the angle of view, various kinds of detection information are stored as learning data, and learning processing is performed in learning mode processing (step S716 of FIG. 7) such that the score of automatic shooting determination becomes high.

Also, when a high smiling level of the person A who is a subject registered by personal authentication registration is detected or an expression “joy” or “surprise” is detected, it is learned that a subject simultaneously included in the angle of view is important. Alternatively, when an expression “anger” or “straight face” of the person A is detected, it is determined that the possibility that a subject simultaneously included in the angle of view is important is low, and learning processing is not performed.

Learning processing in cooperation with an external apparatus will be described next. Learning processing in cooperation with an external apparatus according to the present embodiment is performed using the following methods.
(1) Learning processing performed by obtaining an image by an external apparatus
(2) Learning processing performed by adding a determination value to an image by an external apparatus
(3) Learning processing performed by analyzing an image stored in an external apparatus
(4) Learning processing performed based on information uploaded to a social networking service (SNS) server by an external apparatus
(5) Learning processing performed by changing camera parameters by an external apparatus
(6) Learning processing performed based on information obtained by manually editing an image by an external apparatus

### Learning Processing Performed by Obtaining Image by External Apparatus

As described with reference to FIG. 3, the camera 101 and the external apparatus 301 perform the first communication 302 and the second communication 303. By the first communication 302, image data transmission/reception is performed, and an image in the camera 101 can be transmitted to the external apparatus 301 using a dedicated application of the external apparatus 301. Also, the user can browse the thumbnails of image data stored in the camera 101 using a dedicated application of the external apparatus 301. The user can select an image he/she likes from the thumbnails and confirm it or cause the camera 101 to transmit the image data to the external apparatus 301 by inputting an image obtaining instruction. The possibility that the image selected by the user and obtained is a user's preferred image is very high. Hence, it is determined that the obtained image is an image to be subjected to learning processing. Based on the learning information of the obtained image, learning processing according to the user's preference can be performed.

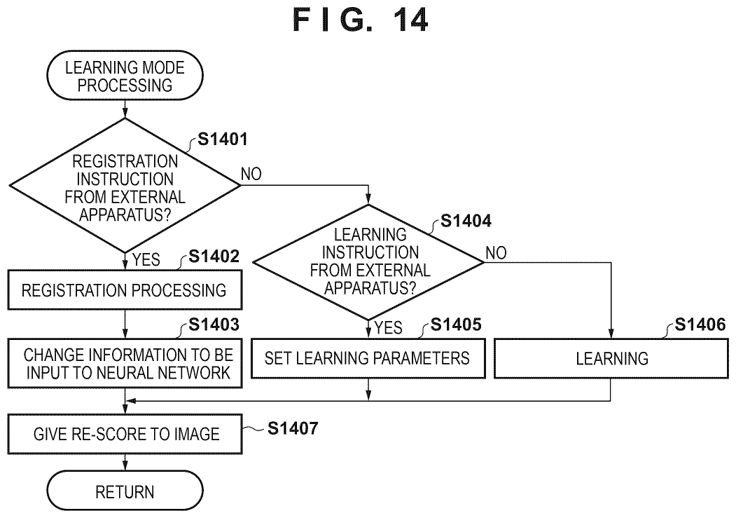

An example of an image selection operation will be described with reference to FIG. 12. FIG. 12 is a view illustrating an example in which the user browses images in the camera 101 using a dedicated application of the external apparatus 301. Thumbnails 1204 to 1209 of image data stored in the camera 101 are displayed on the display unit 407. The user can select and obtain an image he/she likes. Buttons 1201 to 1203 are operated to change the display method.

When the first button 1201 is operated, the mode is changed to a date/time priority display mode, and the images are displayed on the display unit 407 in the order of shooting date/time of the images in the camera 101. For example, an image of a later date/time is displayed at the position indicated by the thumbnail 1204, and an image of an earlier date/time is displayed at the position indicated by the thumbnail 1209. When the second button 1202 is pressed, the mode is changed to a recommended image priority display mode. Based on scores calculated in step S912 of FIG. 9 to determine user's preference for the images, the images in the camera 101 are displayed on the display unit 407 in the descending order of score. For example, an image of a high score is displayed at the position indicated by the thumbnail 1204, and an image of a low score is displayed at the position indicated by the thumbnail 1209. Also, when the user presses the third button 1203, a subject of a person or object can be designated, and a subject of a specific person or object is designated next, only the specific subject can be displayed.

It is also possible to simultaneously turn on the settings of the buttons 1201 to 1203. For example, when all settings are on, only a designated subject is displayed, images of later shooting dates/times are preferentially displayed, and images of high scores are preferentially displayed. Since user's preference is learned even for shot images, only user's preferred images can be extracted by a simple confirmation work from an enormous number of shot images.

### Learning Processing Performed by Adding Determination Value to Image by External Apparatus

The user can browse images stored in the camera 101 and add a score to each image. It is possible to add a high score (for example, 5) to an image that the user likes and add a low score (for example, 1) to an image that the user does not like. The camera learns the determination value of each image in accordance with a user operation. The score for each image is used by the camera for relearning processing together with learning information. The output of the NN that has received feature data from designated image information is subjected to learning processing such that it is closer to a score designated by the user.

Other than the configuration in which the user adds a determination value to an image that has been shot by the external apparatus 301, the user may add a determination value to an image by operating the camera 101. In this case, the camera 101 includes a touch panel display, and the user sets a mode to display an image that has been shot by operating a Graphical User Interface (GUI) button of the touch panel display. When the user sets a determination value for each image while confirming the image that has been shot, the same learning processing as described above can be performed.

### Learning Processing Performed by Analyzing Image Stored in External Apparatus

In the storage unit 404 of the external apparatus 301, images other than the images shot by the camera 101 are also recorded. Since the images stored in the external apparatus 301 are easy for the user to browse and also easy for the public wireless control unit 406 to upload to a sharing server, the possibility that many user's preferred images are included is very high.

Using a dedicated application, the control unit 411 of the external apparatus 301 can process each image stored in the storage unit 404 with the same capability as the learning processing unit 219 of the camera 101. Learning processing is performed by communicating processed learning data to the camera 101. Alternatively, an image or data to be learned may be transmitted to the camera 101, and the camera 101 may perform learning processing. Alternatively, using a dedicated application, the user can select an image to be learned from images stored in the storage unit 404, and learning is thus performed.

### Learning Processing Performed Based on Information Uploaded to SNS Server by External Apparatus

A method of using, for learning processing, information in a social networking service (SNS) that is a service or website capable of establishing a social network with focus on connection between persons will be described. There is a technique of, when uploading an image to an SNS, inputting a tag associated with the image from the external apparatus 301 and transmitting it together with the image. There is also a technique of inputting like/dislike information to images uploaded by other users. It is also possible to determine whether an image uploaded by another user is an image the user holding the external apparatus 301 prefers.

By a dedicated application downloaded to the external apparatus 301, an image uploaded by the user himself/herself and information about the image can be obtained. Also, the user can obtain his/her preferred images or tag information by inputting data indicating like/dislike to images uploaded by other users. The obtained images and tag information are analyzed, and learning processing is performed by the camera 101.

The control unit 411 of the external apparatus 301 can obtain an image uploaded by the user or an image determined to be liked by the user and perform processing with the same capability as the learning processing unit 219 of the camera 101. Learning processing is performed by communicating processed learning data to the camera 101. Alternatively, image data to be learned may be transmitted to the camera 101, and the camera 101 may perform learning processing.

Subject information according to user's preference can be estimated from subject information (for example, object information such as a dog or cat, scene information such as a beach, or expression information such as a smile) set in tag information. In this case, the subject of the detection target is input to the NN, and learning processing is performed. Also, image information that is currently popular in the world can be estimated from the statistic value of tag information (image filter information or subject information) in the SNS and learned by the camera 101.

### Learning Processing Performed by Changing Camera Parameters by External Apparatus

It is possible to transmit learning parameters (the weight coefficient of the NN, selection of a subject to be input to the NN, and the like) currently set in the camera 101 to the external apparatus 301 and store these in the storage unit 404 of the external apparatus 301. Also, using a dedicated application of the external apparatus 301, learning parameters set in a dedicated server are obtained by the public wireless control unit 406. These can also be set to the learning parameters of the camera 101. When the parameters at a certain time are stored in the external apparatus 301 and set in the camera 101, the learning parameters can be returned. Also, learning parameters held by another user can be obtained by a dedicated server and set in the camera 101 of the owner.

In addition, using a dedicated application of the external apparatus 301, voice commands registered by the user, authentication registration, and gestures may be registered, or an important location may be registered. These pieces of information are used as a trigger to start shooting described concerning automatic shooting mode processing in FIG. 9 or input data of automatic shooting determination. In addition, a shooting frequency, an activation interval, the ratio of still images and moving images, and preferred images may be set, and the activation interval described above concerning low power mode control may be set.

### Learning Processing Performed Based on Information Obtained by Manually Editing Image by External Apparatus

It is possible to implement a function capable of performing manual editing in accordance with a user operation by a dedicated application of the external apparatus 301 and feed back the contents of an editing work to learning processing. For example, it is possible to edit image effect application (trimming processing, rotation processing, slide, zoom, fade, color conversion filter effect, time, still image/moving image ratio, and BGM). Learning processing using the NN of automatic editing is performed such that a manually edited image effect application is determined for learning information of an image.

Learning mode processing in step S716 of FIG. 7 will be described next. It is determined, in the mode determination in step S704 of FIG. 7, whether to perform learning processing. Upon determining in step S715 to perform learning processing, learning mode processing in step S716 is executed.

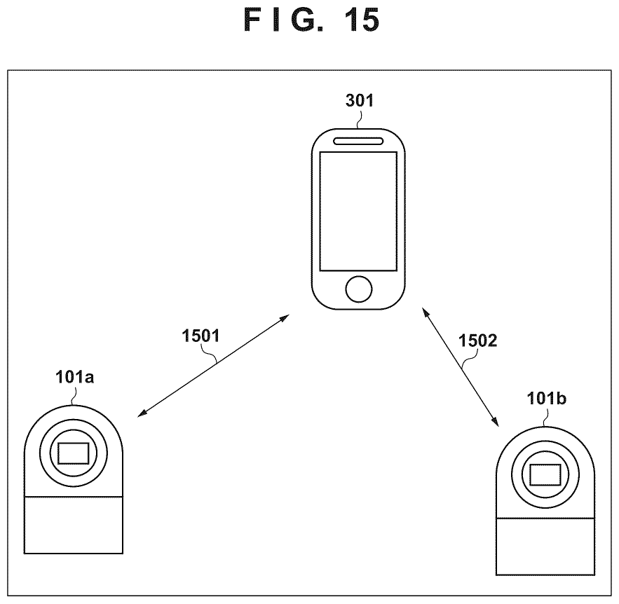

Determination processing of determining whether to perform learning processing will be described here with reference to FIG. 13. Determining whether to perform learning processing is performed based on time elapsed from the time of the preceding learning processing, the number of information usable in learning processing, a learning processing instruction by an external apparatus, and the like.

FIG. 13 is a flowchart exemplifying determination processing of determining whether to perform learning processing, which is executed in step S704 (mode determination processing) and step S715 of FIG. 7.

When mode determination processing is started in step S704, processing shown in FIG. 13 is started.

In step S1301, the first control unit 223 determines whether a registration instruction from the external apparatus 301 exists. The registration instruction is a registration instruction to perform <learning processing performed by obtaining an image by an external apparatus>, <learning processing performed by adding a determination value to an image by an external apparatus>, <learning processing performed by analyzing an image stored in an external apparatus>, and the like. Upon determining in step S1301 that a registration instruction from the external apparatus 301 exists, the process advances to step S1308.

In step S1308, the first control unit 223 sets a flag of learning mode determination to TRUE to set to perform the processing of step S716, and then ends the learning mode determination processing. Upon determining in step S1301 that a registration instruction from the external apparatus 301 does not exist, the process advances to step S1302.

In step S1302, the first control unit 223 determines whether a learning instruction from the external apparatus 301 exists. The learning instruction is an instruction to set learning parameters, like <learning processing performed by changing camera parameters by an external apparatus>. Upon determining in step S1302 that a learning instruction from the external apparatus 301 exists, the process advances to step S1308. Upon determining in step S1302 that a learning instruction from the external apparatus 301 does not exist, the process advances to step S1303.

In step S1303, the first control unit 223 obtains an elapsed time TimeN from the time of the preceding learning processing (recalculation of the weight coefficient of the NN).

In step S1304, the first control unit 223 obtains the new number DN of data for learning. The number DN of data corresponds to the number of images designated to perform learning processing during the elapsed time TimeN from the time of the preceding learning processing.

In step S1305, the first control unit 223 calculates, based on the elapsed time TimeN, a threshold DT used to determine whether to transition to the learning mode. The setting is done such that the smaller the value of the threshold DT is, the easier transition to the learning mode is. For example, the value of the threshold DT in a case where the elapsed time TimeN is smaller than a predetermined value is expressed as DTa, and the value of the threshold DT in a case where the elapsed time TimeN is larger than the predetermined value is expressed as DTb. DTa is set larger than DTb, and the setting is done such that the threshold becomes small along with the elapse of time. Thus, even if there is little learning data, when the elapsed time is long, it is easy to transition to the learning mode, and learning processing is performed again. That is, the setting of easiness for the camera to transition to the learning mode is changed in accordance with the use time.

In step S1306, the first control unit 223 determines whether the number DN of data for learning is larger than the threshold DT. Upon determining that the number DN of data is larger than the threshold DT, the process advances to step S1307. Upon determining that the number DN of data is equal to or smaller than the threshold DT, the process advances to step S1309.

In step S1307, the first control unit 223 sets the number DN of data to zero, and advances to step S1308.

In step S1309, since there is neither a registration instruction nor a learning instruction from the external apparatus 301, and the number DN of learning data is equal to or smaller than the threshold DT, the first control unit 223 sets the flag of learning mode determination to FALSE to set not to perform the processing of step S716, and ends the processing.

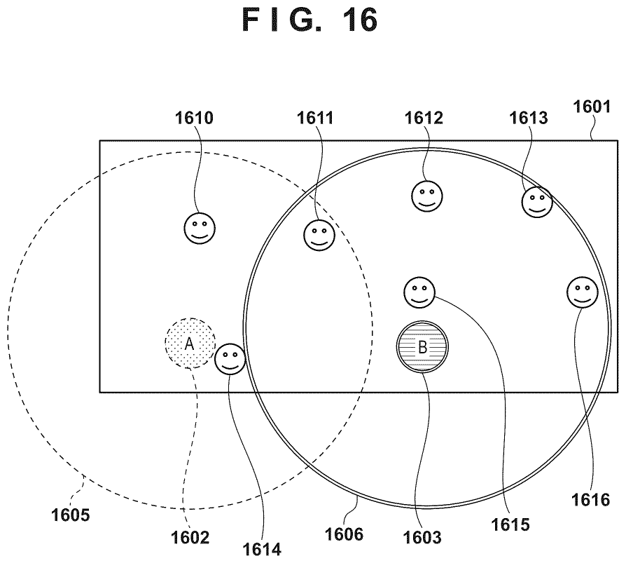

Learning mode processing in step S716 of FIG. 7 will be described next with reference to FIG. 14.

FIG. 14 is a flowchart exemplifying learning mode processing in step S716 of FIG. 7.

The processing shown in FIG. 14 is started upon determining in step S715 of FIG. 7 that the mode is the learning mode.

In step S1401, the first control unit 223 determines whether a registration instruction from the external apparatus 301 exists. Upon determining in step S1401 that a registration instruction from the external apparatus 301 exists, the process advances to step S1402. Upon determining in step S1401 that a registration instruction from the external apparatus 301 does not exist, the process advances to step S1404.

In step S1402, the first control unit 223 executes various kinds of registration processing, and advances to step S1403. The various kinds of registration are registration of features to be input to the NN, and examples are registration of face authentication, registration of general object recognition, registration of sound information, and registration of position information.

In step S1403, the first control unit 223 performs processing of changing information to be input to the NN from the feature information registered in step S1402, and advances to step S1407.

In step S1404, the first control unit 223 determines whether a learning instruction from the external apparatus 301 exists. Upon determining that a learning instruction from the external apparatus 301 exists, the process advances to step S1405. Upon determining that a learning instruction does not exist, the process advances to step S1406.

In step S1405, the first control unit 223 sets the learning parameters communicated from the external apparatus 301 in determiners (the weight coefficient of the NN, and the like), and advances to step S1407.

In step S1406, the first control unit 223 performs learning (recalculation of the weight coefficient of the NN) by the learning processing unit 219, and advances to step S1407. The case where the process advances to step S1406 is a case where the number DN of data exceeds the threshold DT and relearning of each determiner is performed, as described with reference to FIG. 13. When the weight coefficient of the NN is recalculated by relearning using backpropagation or gradient descent, the parameters of the determiners are changed.

In step S1407, the first control unit 223 executes processing of giving scores to the image files stored in the recording medium 221 again. In the present embodiment, scores are given to all image files stored in the recording medium 221 based on the learning result, and automatic editing or automatic file deletion is performed in accordance with the scores. Hence, when relearning or learning parameter setting from the external apparatus is performed, the scores of images that has been shot also need to be updated. After recalculation is performed in step S1407 to give new scores to the image files stored in the recording medium 221, the processing is ended.

In the present embodiment, a method of learning the feature of a scene estimated to meet the user's preference, reflecting the learning result on the operation of the camera such as automatic shooting or automatic editing, and thus obtaining a user's preferred image has been described. However, the method is not limited to this example. For example, the present embodiment can also be applied to an application purpose of daring to use images that do not meet the user's preference, as will be described below.

### Method Using NN That Has Learned User's Preferred Situation

User's preferred learning processing is performed by the above-described method, and automatic shooting determination processing is executed in step S908 of FIG. 9. Automatic shooting is performed when the output value of the NN is a value indicating that it is different from user's preference that is supervisory data. For example, assume a case where an image the user likes is set to a supervisory image and learning processing is performed such that a high value is output when an image exhibits a feature similar to the supervisory image. In this case, reversely, automatic shooting is performed on condition that the output value is lower than a predetermined threshold. Similarly, even in subject search processing or automatic editing processing, processing in which the output value of the NN is a value indicating that it is different from the user's preference that is supervisory data is executed.

Method Using NN That Has Learned Situation Different from User's Preference

At the time of learning processing, learning processing is executed using a situation different from the user's preference as supervisory data. In the present embodiment, a learning method in which a manually shot image is assumed to be a scene shot as the user likes, and this is used as supervisory data has been described. To the contrary, a manually shot image is not used as supervisory data, and processing of adding a scene that is not manually shot for a predetermined time or more as supervisory data is performed. Alternatively, if data of a scene having a feature similar to that of a manually shot image exists among supervisory data, processing of deleting this data from the supervisory data is performed. In addition, processing of adding, to the supervisory data, an image whose feature is different from an image obtained by an external apparatus or processing of deleting, from the supervisory data, an image whose feature is similar to an obtained image is performed. Thus, data different from user's preference are accumulated in the supervisory data, and as a result of learning processing, the NN can discriminate a situation different from user's preference. In automatic shooting, since shooting is performed in accordance with the output value of the NN, a scene different from user's preference can be shot.

By daring to use an image different from user's preference, a scene that the user would not manually shoot is shot, and the number of images missed to shot can be decreased. Also, shooting in a scene unexpected by the user is proposed, thereby promoting the user to notice or widening the width of taste.

When the above-described methods are combined, it is possible to easily propose a situation that meets the user's preference to some extent but not partially or adjust the degree of adaptability to the user's preference. The degree of adaptability to the user's preference can be changed in accordance with the set mode, the states of various kinds of sensors, and the state of detection information.

In the present embodiment, a configuration in which learning processing is performed by the camera 101 has been described. On the other hand, if the external apparatus 301 has a learning function, the same learning effect as described above can be implemented by a configuration in which data necessary for learning processing is transmitted to the external apparatus 301, and learning processing is executed by the external apparatus 301. For example, as described in <learning processing performed by changing camera parameters by an external apparatus>, learning processing may be performed by setting the parameters such as the weight coefficient of the NN learned by the external apparatus 301 by communication with the camera 101.

There is also a form in which the camera 101 and the external apparatus 301 each have a learning function. For example, learning information held by the external apparatus 301 is transmitted to the camera 101 at the timing of performing learning mode processing (step S716 of FIG. 7) in the camera 101, the learning parameters are integrated (merged), and learning processing is performed using the integrated learning parameters.

### System Configuration

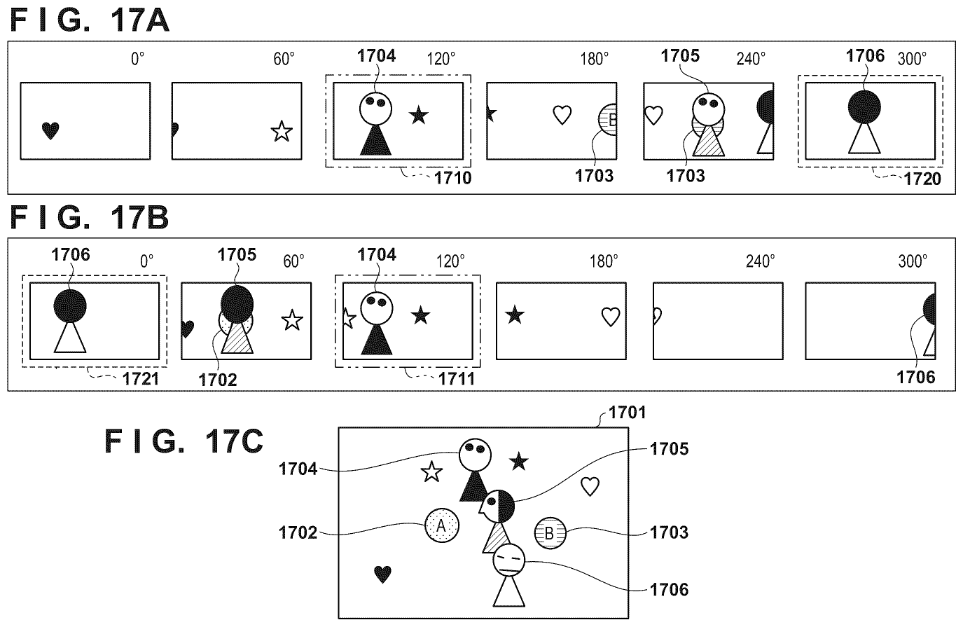

A system in which an external apparatus controls a plurality of cameras to perform shooting will be described next with reference to FIGS. 15 to 30B.

Note that an example in which two cameras 101a and 101b installed at different positions are connected to the external apparatus 301 will be described below, but three or more cameras may be connected.

The configurations and functions of the cameras 101a and 101b and the external apparatus 301 are the same as described with reference to FIGS. 1A to 14.

FIG. 15 is a view exemplifying a system that performs shooting by controlling a plurality of cameras.

In the system according to the present embodiment, the plurality of cameras 101a and 101b and the external apparatus 301 are connected such that these can perform wireless communications 1501 and 1502. In the example shown in FIG. 15, the two cameras 101a and 101b and the external apparatus 301 are connected such that these can perform the wireless communications 1501 and 1502. However, three or more cameras may be connected. The wireless communications 1501 and 1502 are a wireless LAN or BLE. The external apparatus 301 can be connected to the plurality of cameras 101a and 101b, and can identity the plurality of cameras based on specific information received from the cameras 101a and 101b. As the specific information for identifying the plurality of cameras, a MAC address or an individual number added at the time of manufacturing can be used. The external apparatus 301 transmits shooting control information to the cameras 101a and 101b and receives omnidirectional images from the cameras 101a and 101b.

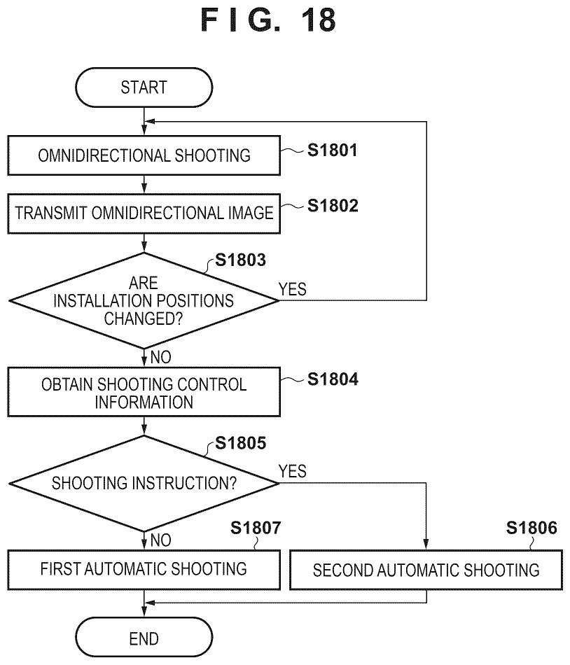

FIG. 16 exemplifies a state in which a plurality of subjects exist in the shooting ranges of a plurality of cameras.

In FIG. 16, a camera A 1602, a camera B 1603, and persons 1610 to 1616 exist in a predetermined area 1601, and the camera A 1602 and the camera B 1603 independently perform automatic shooting. The shooting range of the camera A 1602 is indicated by an angle 1605 of view, and the shooting range of the camera B 1603 is indicated by an angle 1606 of view.

In the example shown in FIG. 16, the person 1611 is included in the shooting ranges of both the camera A 1602 and the camera B 1603, and the camera A 1602 and the camera B 1603 may shoot the same person. In addition, the person 1611 is likely to appear similar whether the image is shot by the camera A 1602 or the camera B 1603.

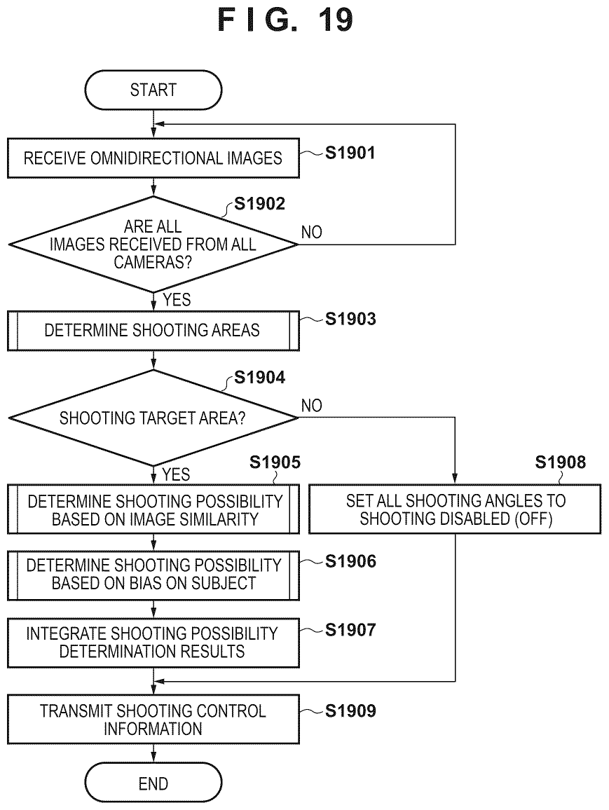

FIGS. 17A to 17C exemplify images obtained by omnidirectional shooting by the camera A 1602 and the camera B 1603.

FIG. 17C exemplifies a state in which two cameras and three persons exist in a predetermined area 1701.

A camera A 1702 and a camera B 1703 can shoot, by pan driving, all directions at an interval of 60° starting from the reference angle of the camera. Persons 1704 to 1706 are located at intermediate positions between the camera A 1702 and the camera B 1703. FIG. 17A shows images obtained by shooting all directions by the camera A 1702, and FIG. 17B shows images obtained by shooting all directions by the camera B 1703.

FIGS. 17A and 17B exemplify a state in which the person 1704 is shot from the front at 120° in FIG. 17A, the person 1705 is shot from the front at 240° in FIG. 17A, and the person 1704 is shot from the front at 120° in FIG. 17B.

The person 1706 at 300° in FIG. 17A, the person 1706 at 0° in FIG. 17B, the person 1705 at 60° in FIG. 17B, and the person 1706 at 300° in FIG. 17B exemplify a state in which the subjects are shot from behind.

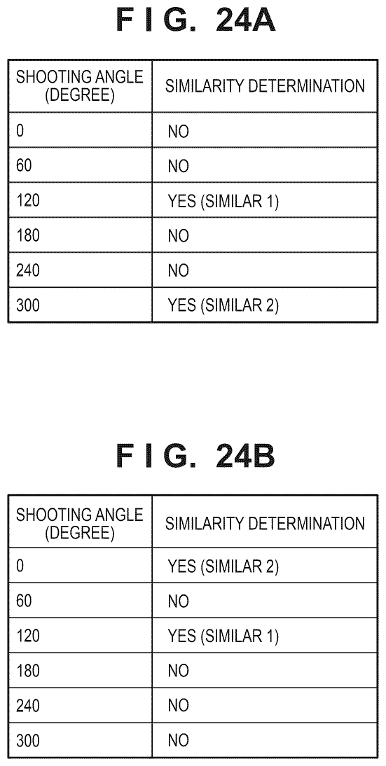

Here, an image 1710 shot at an angle of 120° in FIG. 17A and an image 1711 shot at an angle of 120° in FIG. 17B are similar. Also, an image 1720 shot at an angle of 300° in FIG. 17A and an image 1721 shot at an angle of 0° in FIG. 17B are similar. An image similarity determination method will be described later with reference to FIG. 23.

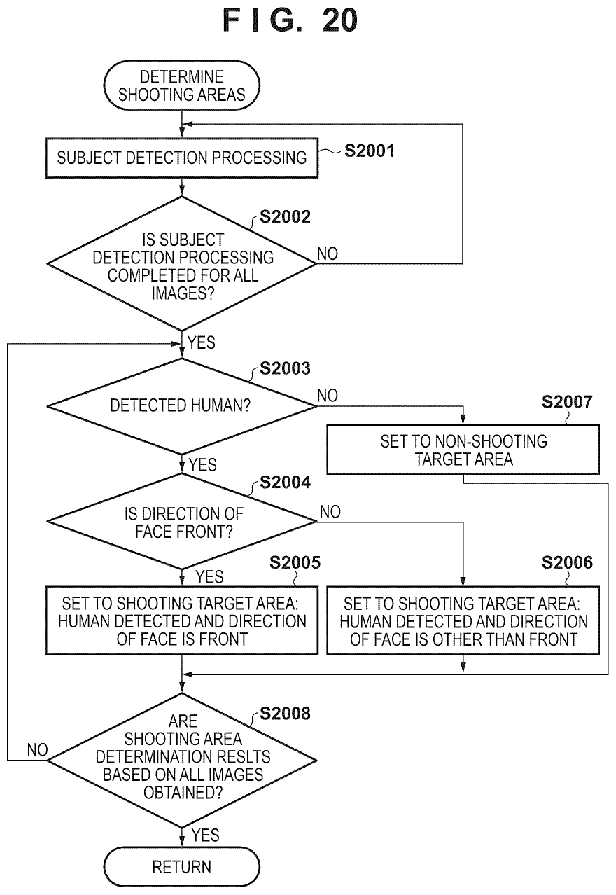

FIG. 18 is a flowchart exemplifying control processing of the cameras 101a and 101b of the system according to the present embodiment.

The cameras 101a and 101b according to the present embodiment can execute automatic shooting, as described with reference to FIGS. 7 and 9. When these are connected to the external apparatus 301, as shown in FIG. 15, the cameras 101a and 101b execute processing shown in FIG. 18 in place of the processing shown in FIG. 9.

The processing shown in FIG. 18 is implemented by the first control unit 223 of the camera 101 executing a program stored in the nonvolatile memory 216.

In step S1801, the first control unit 223 performs omnidirectional shooting processing. As shown in FIGS. 17A to 17C, the first control unit 223 pan-drives the cameras 101a and 101b, thereby performing shooting at an interval of 60° for the shooting range of 360°.

In step S1802, the first control unit 223 transmits omnidirectional images shot in step S1801 to the external apparatus 301. In this case, a shooting angle is added as additional information to each shot image such that the shot image and the shooting angle can be handled as a set.

In step S1803, the first control unit 223 determines whether the installation positions of the cameras 101a and 101b are changed. The installation positions of the cameras 101a and 101b are detected using a gyro sensor and an acceleration sensor provided in the cameras 101a and 101b. When moving information and motion detection information are obtained using the gyro sensor and the acceleration sensor, it is possible to determine whether the installation positions of the cameras 101a and 101b are moved. When the installation positions of the cameras 101a and 101b are changed, the process returns to step S1801 to redo shooting of omnidirectional images.

In step S1804, the first control unit 223 obtains shooting control information from the external apparatus 301.

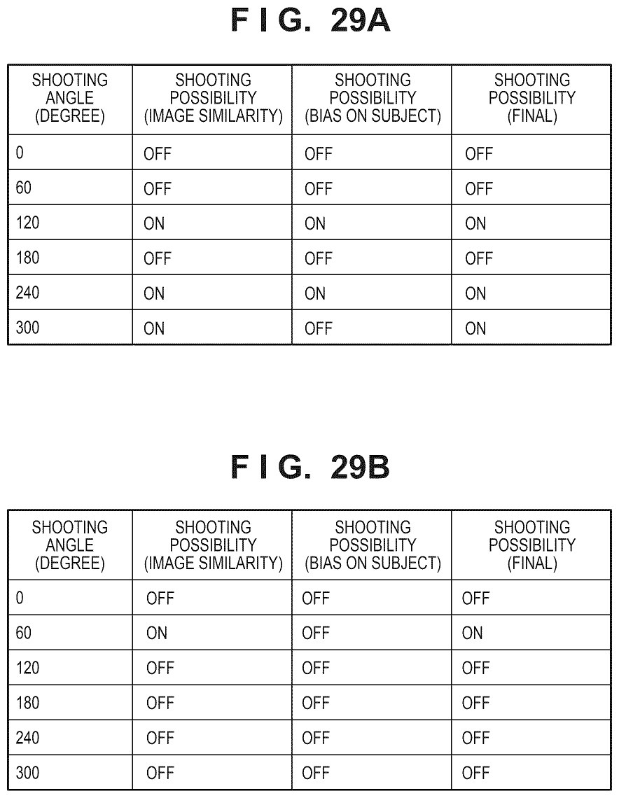

In step S1805, the first control unit 223 determines whether the shooting control information obtained from the external apparatus 301 includes a shooting instruction. In the present embodiment, when all shooting possibility settings to be described later with reference to FIGS. 29A and 29B are off, it is determined that a shooting instruction is not included. When a shooting instruction is included in the shooting control information obtained from the external apparatus 301, the process advances to step S1806. When a shooting instruction is not included, the process advances to step S1807.

In step S1806, the first control unit 223 performs second automatic shooting based on the shooting instruction obtained from the external apparatus 301. The shooting instruction is notified in a state in which shooting possibility is set for each shooting angle, as shown in FIGS. 29A and 29B. The cameras 101a and 101b are each pan-driven to a shooting angle for which the shooting possibility is set to be on (shooting enabled) based on the shooting instruction obtained from the external apparatus 301, and shooting processing in step S910 of FIG. 9 is performed for a main subject determined by subject search processing by the NN.

In step S1807, the first control unit 223 performs first automatic shooting. When a shooting instruction is not included in the shooting control information obtained from the external apparatus 301, that is, when all shooting possibility settings to be described later with reference to FIGS. 29A and 29B are off, the cameras 101a and 101b perform automatic shooting shown in FIG. 9.

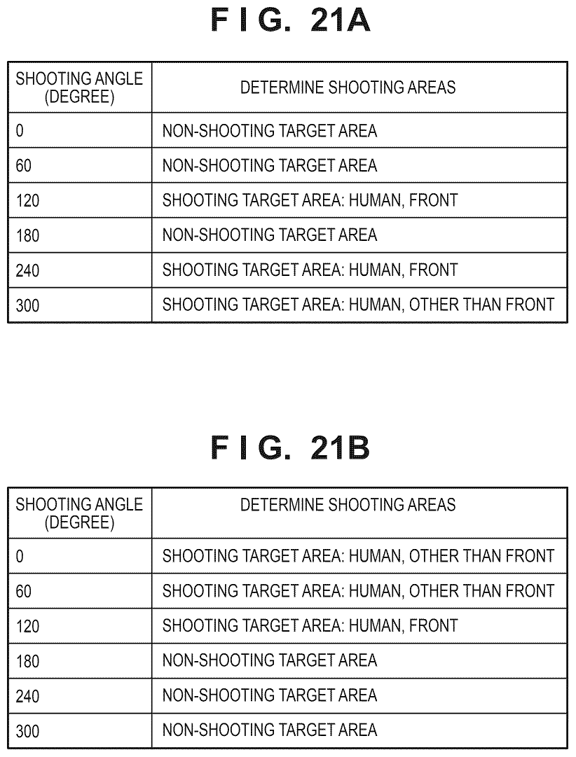

Control processing of the external apparatus 301 of the system according to the present embodiment will be described next with reference to FIG. 19.

The processing shown in FIG. 19 is implemented by the control unit 411 of the external apparatus 301 executing a program stored in the storage unit 404.

In step S1901, the control unit 411 waits until omnidirectional images are received from all the cameras 101a and 101b in step S1802 of FIG. 18. Upon determining that omnidirectional images are received from all the cameras 101a and 101b connected to the external apparatus 301, the process advances to step S1903.

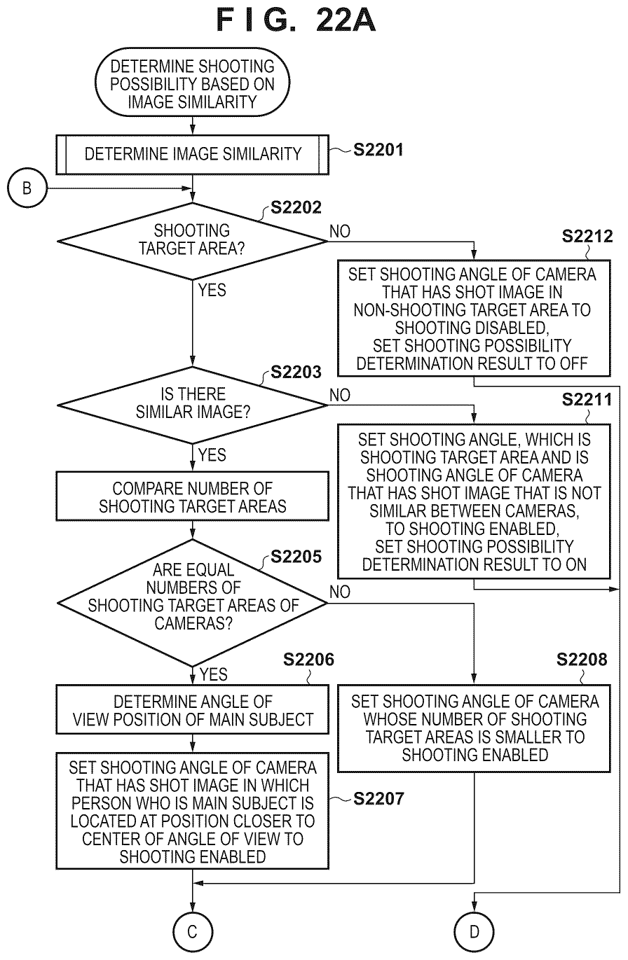

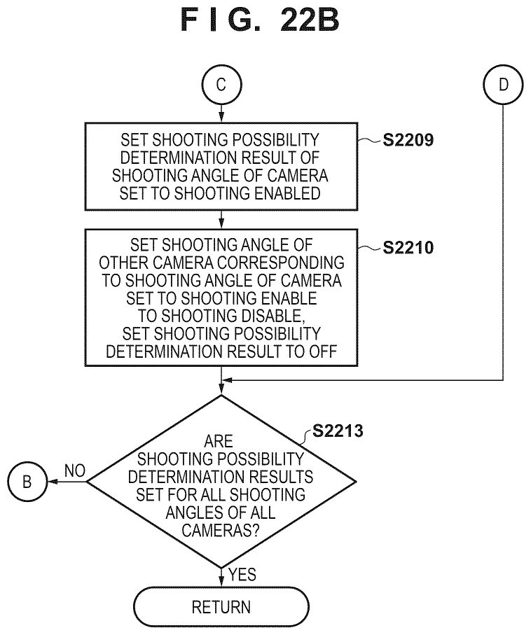

In step S1903, the control unit 411 determines shooting areas for the images of all shooting angles received in step S1902. FIGS. 21A and 21B exemplify shooting area determination results. The shooting area determination result includes, for each shooting angle, one of a non-shooting target area, a shooting target area (a person, front), a shooting target area (a person, other than front). The shooting area determination processing will be described later with reference to FIG. 20.

In step S1904, the control unit 411 determines, based on the result of determining a shooting area in step S1903, whether a shooting target area exists. Upon determining that a shooting target area exists, the process advances to step S1905. Upon determining that a shooting target area does not exist, that is, when the areas of all shooting angles are non-shooting target areas in FIGS. 21A and 21B, the process advances to step S1908.

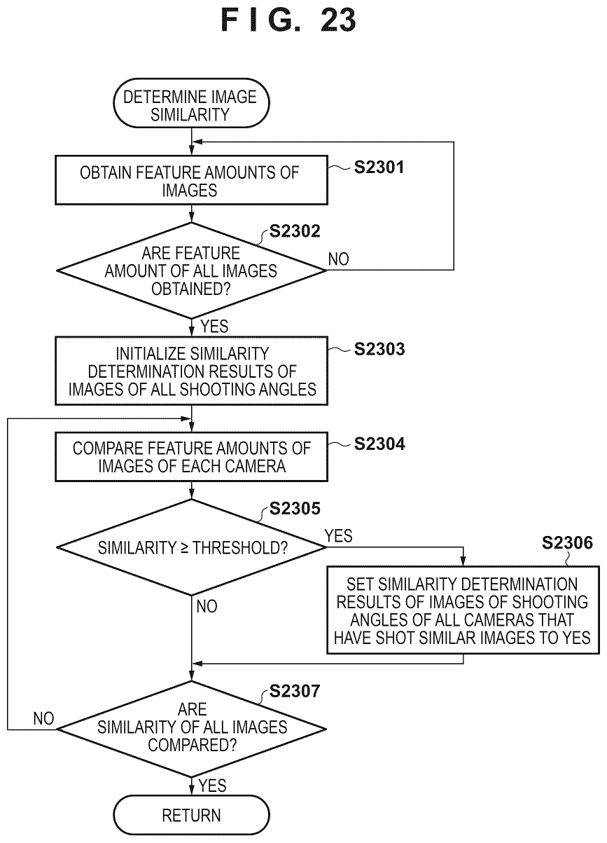

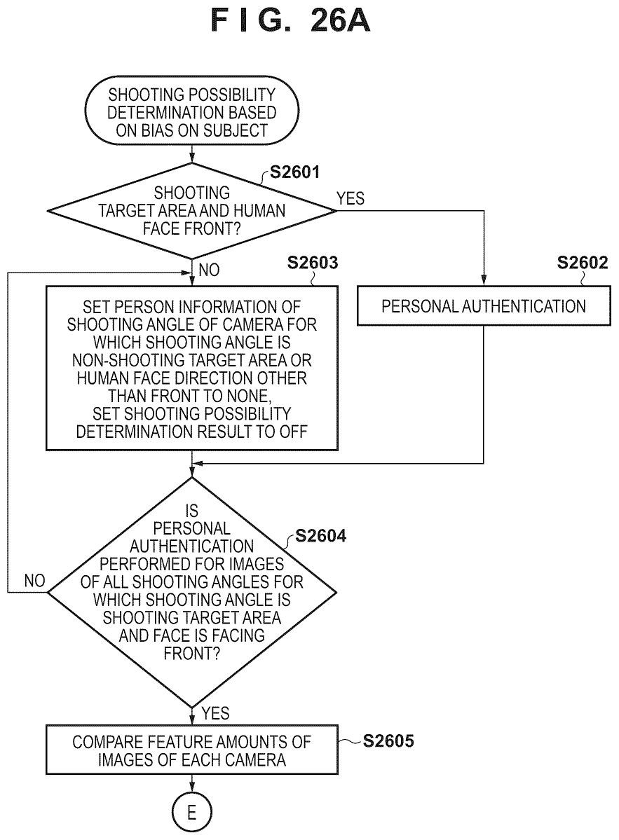

In step S1905, the control unit 411 performs shooting possibility determination based on image similarity in a case where a shooting target area exists. The control unit 411 evaluates the similarity between the shot images of the cameras 101a and 101b and controls such that the shooting target areas do not overlap for images with high similarity. FIGS. 25A and 25B exemplify shooting possibility determination results based on image similarity. The shooting possibility determination results based on image similarity are stored in a table format, and a result of determining whether to perform shooting is included for each shooting angle. FIG. 25A exemplifies the shooting possibility determination results of the camera A 1702 shown in FIG. 17C, and FIG. 25B exemplifies the shooting possibility determination results of the camera B 1703 shown in FIG. 17C. Shooting possibility determination processing based on image similarity will be described later with reference to FIGS. 22A and 22B.

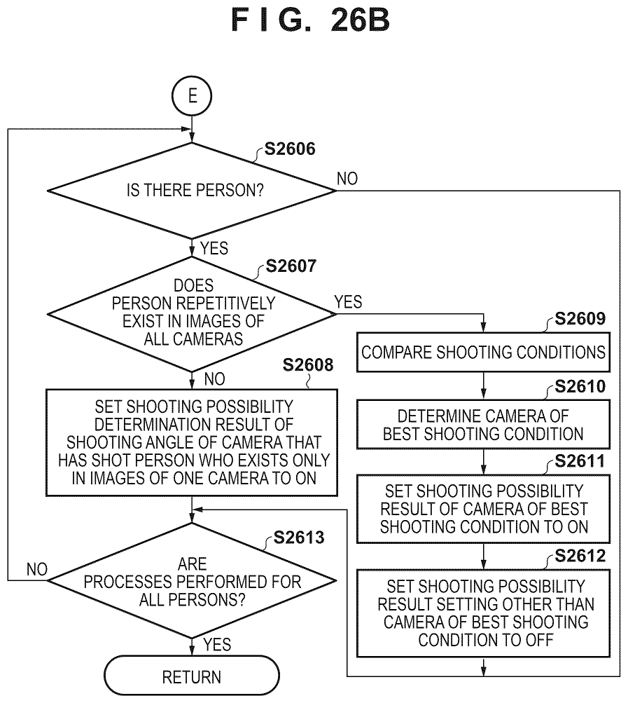

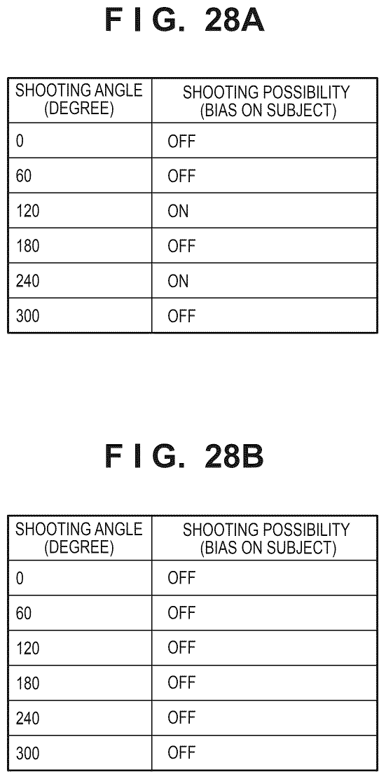

In step S1906, the control unit 411 performs shooting possibility determination based on a bias on a subject in a case where a shooting target area exists. Based on a subject detection result for the shot images of the cameras 101a and 101b, the control unit 411 controls such that the shooting target areas do not overlap so as to prevent shooting with a bias on the same subject (shooting the same subject over and over again). FIGS. 28A and 28B exemplify shooting possibility determination results based on a bias on a subject. The shooting possibility determination results based on a bias on a subject are stored in a table format, and a result of determining whether to perform shooting is included for each shooting angle. FIG. 28A exemplifies the shooting possibility determination results of the camera A 1702 shown in FIG. 17C, and FIG. 28B exemplifies the shooting possibility determination results of the camera B 1703 shown in FIG. 17C. Shooting possibility determination processing based on a bias on a subject will be described later with reference to FIGS. 26A and 26B.

In step S1907, the control unit 411 integrates the shooting possibility determination results obtained in steps S1905 and S1906. FIGS. 29A and 29B exemplify final shooting possibility determination results obtained by integrating the shooting possibility determination results in step S1905 shown in FIGS. 25A and 25B and the shooting possibility determination results in step S1906 shown in FIGS. 28A and 28B. FIG. 29A exemplifies the final shooting possibility determination results of the camera A 1702 shown in FIG. 17C, and FIG. 29B exemplifies the final shooting possibility determination results of the camera B 1703 shown in FIG. 17C. The final shooting possibility determination result is obtained by the OR between the shooting possibility determination result based on image similarity and the shooting possibility determination result based on a bias on a subject, and the final shooting possibility determination results are stored in a table format.

In step S1908, since there is no shooting target area, the control unit 411 sets all the final shooting possibility determination results for the shooting angles shown in FIGS. 29A and 29B off, thereby preventing a shooting instruction from being included in the shooting control information.

In step S1909, the control unit 411 transmits the shooting control information to the cameras 101a and 101b. The control unit 411 transmits the shooting possibility determination results obtained in step S1907 or S1908 to the cameras 101a and 101b.

Shooting area determination processing in step S1903 of FIG. 19 will be described next with reference to FIG. 20.

In step S2001, the control unit 411 performs subject detection processing for the images obtained in step S1901 of FIG. 19. In the subject detection processing, a human face or a human body is detected as a subject using a known method such as a method using pattern matching or a method using an NN. Also, the control unit 411 obtains the direction of the human face or human body detected by the subject detection processing.

In step S2002, the control unit 411 determines whether the subject detection processing is completed for the images of all the areas (shooting angles) of all the cameras. Upon determining that the subject detection processing is completed for the images of all the areas (shooting angles) of all the cameras, the process advances to step S2003. Upon determining that the subject detection processing is not completed for the images of all the areas (shooting angles) of all the cameras, the process returns to step S2001 to continue the processing.

In step S2003, the control unit 411 determines whether a human face or human body is detected by the subject detection processing in step S2001. Upon determining that a human face or human body is detected, the process advances to step S2003. Upon determining that a human face or human body is not detected, the process advances to step S2007.

In step S2004, the control unit 411 determines whether the direction of the human face or human body detected in step S2001 is front. When a plurality of human faces or human bodies are detected in step S2001, the direction of the human face or human body of the main subject is determined. Upon determining that the direction of the human face or human body is front, the process advances to step S2005. When the human face or human body faces aside or backward, the process advances to step S2006.

In steps S2005 to S2007, the control unit 411 sets a shooting target area for each camera based on the determination results (whether a human face or human body is detected and the direction of the human face or human body) in steps S2003 and S2004. In step S2005, the shooting angle of each image in which a human face or human body is detected and the human face or human body faces front is set to a shooting target area, and the set value is stored in the storage unit 404. In step S2006, the shooting angle of each image in which a human face or human body is detected and the human face or human body faces a direction other than front is set to a shooting target area, and the set value is stored in the storage unit 404. In step S2007, the shooting angle of each image in which neither a human face nor a human body is detected is set to a non-shooting target area, and the set value is stored in the storage unit 404. FIGS. 21A and 21B exemplify shooting area determination results for each camera and each shooting angle. The shooting area determination results are stored in a table format. FIG. 21A shows the shooting area determination result based on the subject detection result for each image shown in FIG. 17A, which is shot by the camera A 1702. In the example shown in FIG. 21A, shooting angles of 120° and 240° at which a human face is detected and the human face faces a direction other than front in the images shown in FIG. 17A and a shooting angle of 300° at which a human face is detected and the human face faces a direction other than front are set to shooting target areas, and shooting angles of 0°, 60°, and 180° except these are set to non-shooting target areas. FIG. 21B shows the shooting area determination result based on the subject detection result for each image shown in FIG. 17B, which is shot by the camera B 1703. In the example shown in FIG. 21B, a shooting angle of 120° at which a human face is detected and the human face faces a direction other than front in the images shown in FIG. 17B and shooting angles of 0° and 60° at which a human face is detected and the human face faces a direction other than front are set to shooting target areas, and shooting angles of 180°, 240°, and 300° except these are set to non-shooting target areas.

In step S2008, the control unit 411 determines whether the shooting area determination results are obtained for the images of all the areas (shooting angles) of all the cameras. Upon determining that the shooting area determination results based on the images of all the areas (shooting angles) of all the cameras are obtained, the processing is ended. Upon determining that the shooting area determination results based on the images of all the areas (shooting angles) of all the cameras are not obtained, the process returns to step S2003 to continue the processing.

Shooting possibility determination processing based on image similarity in step S1905 of FIG. 19 will be described next with reference to FIGS. 22A and 22B.

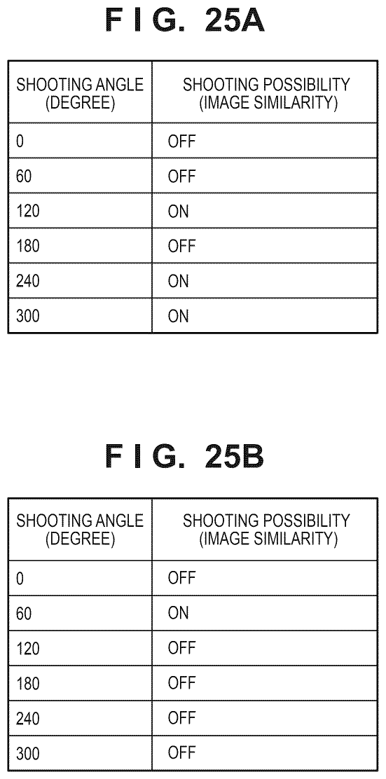

In step S2201, the control unit 411 determines, for the images of all the shooting angles of all the cameras, whether there similar images, and stores the determination results in the storage unit 404. Details of the similarity determination processing will be described later with reference to FIG. 23. FIGS. 24A and 24B exemplify similarity determination results for the images of all the shooting angles of the all the cameras. The image similarity determination results are stored in a table format. When similar images exist, a discriminable index is added, as a similarity determination result for each camera, to the shooting angle at which a similar image is shot. FIG. 24A shows the similarity determination results of the images shown in FIG. 17A shot by the camera A 1702 to the images shown in FIG. 17B shot by the camera B 1703. In the example shown in FIG. 24A, an index (YES) indicating that the image is similar and an index (similar 1) indicating a similar image are set for the shooting angle of the image of a shooting angle of 120° in FIG. 17A, which is similar to the image of a shooting angle of 120° in FIG. 17B, and an index (YES) indicating that the image is similar and an index (similar 2) indicating a similar image are set for the shooting angle of the image of a shooting angle of 300° in FIG. 17A, which is similar to the image of a shooting angle of 0° in FIG. 17B. FIG. 24B shows the similarity determination results of the images shown in FIG. 17B shot by the camera B 1703 to the images shown in FIG. 17A shot by the camera A 1702. In the example shown in FIG. 24B, an index (YES) indicating that the image is similar and an index (similar 1) indicating a similar image are set for the shooting angle of the image of a shooting angle of 120° in FIG. 17B, which is similar to the image of a shooting angle of 120° in FIG. 17A, and an index (YES) indicating that the image is similar and an index (similar 2) indicating a similar image are set for the shooting angle of the image of a shooting angle of 0° in FIG. 17B, which is similar to the image of a shooting angle of 300° in FIG. 17A.

In step S2202, by referring to the shooting area determination results shown in FIGS. 21A and 21B, the control unit 411 determines, for all the shooting angles of all the cameras, whether the shooting angle is a shooting target area. Upon determining that the shooting angle of the camera of the determination target is a shooting target area, the process advances to step S2203. Upon determining that the shooting angle of the camera of the determination target is a non-shooting target area, the process advances to step S2212.

In step S2203, by referring to the similarity determination results shown in FIGS. 24A and 24B, the control unit 411 determines, for all the shooting angles of all the cameras, whether there is a similar image. Upon determining that there is a similar image, the process advances to step S2204. Upon determining that there is no similar image, the process advances to step S2211.

In step S2204, by referring to the shooting area determination results shown in FIGS. 21A and 21B, the control unit 411 compares the numbers of shooting target areas of the cameras. In the example shown in FIGS. 21A and 21B, the number of shooting target areas of the camera A 1702 equals the number of shooting target areas of the camera B 1703 (the number is three).

In step S2205, the control unit 411 determines, based on the result of comparison of the numbers of shooting target areas of the cameras in step S2204, whether the numbers of shooting target areas of the cameras equal. Upon determining that the numbers of shooting target areas of the cameras equal, the process advances to step S2206. Upon determining that the numbers of shooting target areas of the cameras are different, the process advances to step S2208.

In step S2206, the control unit 411 refers to the subject detection result in step S2001 of FIG. 20 for the images shot by the cameras and determined to be similar in step S2203, and determines an image in which the person who is the main subject is located at a position closer to the center of the angle of view among the similar images shot by the cameras.

In step S2207, based on the result of determination in step S2206, the control unit 411 sets the shooting angle of the camera that has shot the image in which the person who is the main subject is located at a position closer to the center of the angle of view to shooting enabled.

In step S2208, based on the result of determination in step S2205, the control unit 411 sets the shooting angle of the camera whose number of shooting target areas is smaller to shooting enabled.

In step S2209, the control unit 411 sets the shooting possibility determination result of the shooting angle of the camera set to shooting enabled in steps S2207 and S2208 on, and stores the set value in the storage unit 404. In the example shown in FIGS. 21A and 21B, the number of shooting target areas of the camera A 1702 equals that of the camera B 1703. Hence, of the image of a shooting angle of 120° in FIG. 17A and the image of a shooting angle of 120° in FIG. 17B which are similar, the shooting angle of the camera that has shot the image in FIG. 17A in which the person is located at a position closer to the center of the angle of view in steps S2206 and S2207 is set to shooting enabled. Also, in the example shown in FIGS. 21A and 21B, of the image of a shooting angle of 300° in FIG. 17A and the image of a shooting angle of 0° in FIG. 17B which are similar, the shooting angle of the camera that has shot the image in FIG. 17A in which the person is located at a position closer to the center of the angle of view in steps S2206 and S2207 is set to shooting enabled. In the example shown in FIGS. 24A and 24B, of the image of a shooting angle of 120° in FIG. 24A and the image of a shooting angle of 120° in FIG. 24B which are similar, the shooting angle of the camera that has shot the image in FIG. 24A in which the person is located at a position closer to the center of the angle of view is set to shooting enabled. Also, in the example shown in FIGS. 24A and 24B, of the image of a shooting angle of 300° in FIG. 24A and the image of a shooting angle of 0° in FIG. 24B which are similar, the shooting angle of the camera that has shot the image in FIG. 24A in which the person is located at a position closer to the center of the angle of view in steps S2206 and S2207 is set to shooting enabled.

In step S2210, the control unit 411 sets the shooting angle of the other camera corresponding to the shooting angle of the camera set to shooting enabled in step S2209 to shooting disabled, sets the shooting possibility determination result to off, and stores the set value in the storage unit 404.

FIGS. 25A and 25B exemplify the shooting possibility determination results based on image similarity. The shooting possibility determination results based on image similarity are stored in a table format. FIG. 25A shows the shooting possibility determination results for the shooting angles of the camera A 1702. In the example shown in FIG. 25A, the shooting possibility determination results of shooting angles of 120° and 300° of the camera A 1702 in FIG. 24A are set to on. FIG. 25B shows the shooting possibility determination results for the shooting angles of the camera B 1703. In the example shown in FIG. 25B, the shooting possibilities of shooting angles of 120° and 300° of the camera B 1703 in FIG. 24B are set to off (shooting disabled).

In step S2211, the control unit 411 sets a shooting angle, which is a shooting target area and is the shooting angle of the camera that has shot an image that is not similar between the cameras, to shooting enabled, sets the shooting possibility determination result on, and stores the set value in the storage unit 404. In the example shown in FIGS. 21A and 21B and FIGS. 24A and 24B, a shooting angle of 240° of the camera A 1702 in FIG. 17A and a shooting angle of 60° of the camera B 1703 in FIG. 17B are set to shooting enabled because both are shooting target areas but the images are not similar, and the shooting possibility determination results of a shooting angle of 240° of the camera A 1702 in FIG. 25A and a shooting angle of 60° of the camera B 1703 in FIG. 25B are set to on.

In step S2212, the control unit 411 sets the shooting angle of the camera that has shot an image in a non-shooting target area to shooting disabled, sets the shooting possibility determination result to off, and stores the set value in the storage unit 404. In the example shown in FIGS. 21A and 21B and FIGS. 24A and 24B, shooting angles of 0°, 60°, and 180° of the camera A 1702 in FIG. 17A and shooting angles of 180°, 240°, and 300° of the camera B 1703 in FIG. 17B are set to shooting disabled because these are non-shooting target areas, and the shooting possibility determination results of shooting angles of 0°, 60°, and 180° of the camera A 1702 in FIG. 25A and shooting angles of 180°, 240°, and 300° of the camera B 1703 in FIG. 25B are set to off.

In step S2213, the control unit 411 determines whether the shooting possibility determination results are set for all the shooting angles of all the cameras. Upon determining that the shooting possibility determination results are set for all the shooting angles of all the cameras, the processing is ended. Upon determining that the shooting possibility determination results are not set for all the shooting angles of all the cameras, the process returns to step S2202 to continue the processing.

Similarity determination processing for the images of all the shooting angles of all the cameras in step S2201 of FIG. 22A will be described next with reference to FIG. 23.

In step S2301, the control unit 411 obtains the feature amounts of the images of all the shooting angles of all the cameras, and the feature amount of each image is numerically expressed by applying a feature detector. As a method of numerically expressing an image feature amount, a known method such as AKAZE can be used.

In step S2302, the control unit 411 determines whether the feature amounts of the images of all the shooting angles of all the cameras are obtained. Upon determining that the feature amounts of the images of all the shooting angles of all the cameras are obtained, the process advances to step S2303. Upon determining that the feature amounts of the images of all the shooting angles of all the cameras are not obtained, the process returns to step S2301 to continue the processing until the feature amounts of the images of all the shooting angles of all the cameras are obtained.

In step S2303, the control unit 411 initializes the similarity determination results of the images of all the shooting angles of all the cameras in preceding processing. In the example shown in FIGS. 24A and 24B, data “NO” indicating that there exists no similar image is set for the similar image determination result for each shooting angle of the camera A 1702 in FIG. 24A and the similar image determination result for each shooting angle of the camera B 1703 in FIG. 24B.

In step S2304, the control unit 411 compares the feature amounts of the images for each shooting angle of each camera obtained in step S2301. In the feature amount comparison, the distance of the feature amount of an image is calculated for each shooting angle of each camera using a known method called matching, and the average of the distances is calculated as a similarity.

In step S2305, the control unit 411 compares the similarity calculated in step S2304 with a threshold, and determines whether the similarity is equal to or larger than the threshold. When the similarity is equal to or larger than the threshold, it is determined that the images are similar, and the process advances to step S2306. When the similarity is smaller than the threshold, it is determined that the images are not similar, and the process advances to step S2307.

In step S2306, since it is determined that the images are similar, the control unit 411 sets the similarity determination results of the images of the shooting angles of all the cameras that have shot the similar images to YES, and stores the set values in the storage unit 404. In the example shown in FIGS. 17A to 17C and FIGS. 24A and 24B, since it is determined that the image at the shooting angle of 120° of the camera A 1702 in FIG. 24A and the image at the shooting angle of 120° of the camera B 1703 in FIG. 24B are similar, the index (YES) indicating that the images are similar and the indices (similar 1 and similar 2) indicating similar images are set for the shooting angles of 120° and 300° in FIG. 24A and the shooting angles of 120° and 0° in FIG. 24B. In the example shown in FIGS. 24A and 24B, a number numbered in 1 origin is added to a suffix as similar 1.

In step S2307, it is determined whether similarity comparison is performed for the images of all the shooting angles of all the cameras. Upon determining that similarity comparison is performed for the images of all the shooting angles of all the cameras, the processing is ended. Upon determining that similarity comparison is not performed for the images of all the shooting angles of all the cameras, the process returns to step S2304 to continue the processing until similarity comparison is completed for the images of all the shooting angles of all the cameras.

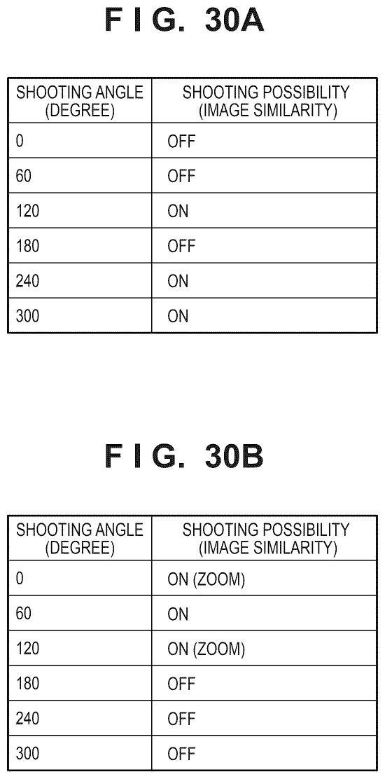

Note that in step S2210 of FIG. 22B, when similar images exist for all the shooting angles of all the cameras, the shooting possibility determination result of a shooting angle of the other camera corresponding to a shooting angle of the camera for which the shooting possibility determination result is set to on is set to off. However, another processing may be applied. For example, as shown in FIGS. 30A and 30B, control may be performed such that instead of setting the shooting possibility determination result off in accordance with the similar image determination result, the shooting possibility determination result is set to on, and shooting is performed by changing the angle of view by zoom. As a method of changing the angle of view, a method of enlarging the subject by the zoom unit 201 or a method of performing cutout and enlargement by image processing can be used.

Shooting possibility determination processing based on a bias on a subject in step S1906 of FIG. 19 will be described next with reference to FIGS. 26A and 26B.

In step S2601, the control unit 411 refers to the shooting possibility determination results shown in FIGS. 21A and 21B, and determines, for the images of all the shooting angles of all the cameras, whether a shooting angle is a shooting target area and a human face or human body faces front. Upon determining that the shooting angle of the camera of the determination target is a shooting target area and a human face or human body faces front, the process advances to step S2602. Upon determining that the shooting angle of the camera of the determination target is a non-shooting target area or a human face or human body faces a direction other than front, the process advances to step S2603.

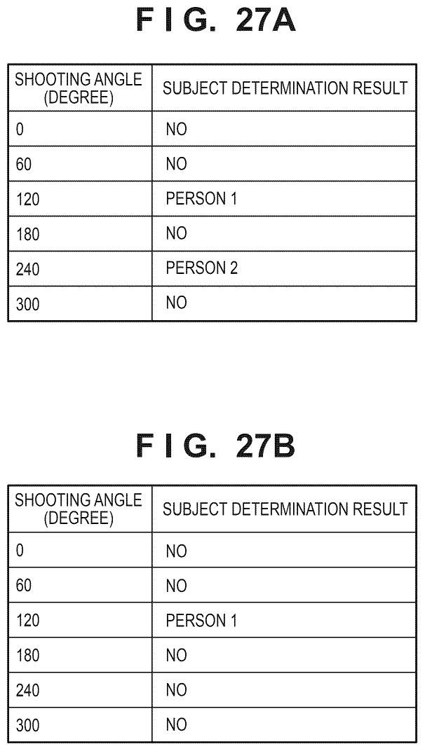

In step S2602, the control unit 411 performs personal authentication processing of a person for which it is determined in step S2601 that the shooting angle is a shooting target area and the human face or human body faces front, and stores the authentication result in the storage unit 404. For the personal authentication processing of the person, a known method of numerically expressing the feature amount of the whole face or each organ of the face can be applied. FIGS. 27A and 27B exemplify subject determination results by personal authentication. The subject determination results by personal authentication are stored in a table format. In FIG. 27A, of the images of the camera A 1702 shown in FIG. 17A, person 1 (person name) extracted from the image of the shooting angle of 120° is registered, and person 2 (person name) extracted from the image of the shooting angle of 240° is registered.

In step S2603, the control unit 411 sets person information of a shooting angle of a camera for which the shooting angle is a non-shooting target area or the human face or human body faces a direction other than front in step S2601 to none, sets the shooting possibility determination result to off, and stores the set value in the storage unit 404. In the example shown in FIGS. 27A and 27B, person information of a shooting angle of a camera for which the shooting angle is a non-shooting target area or the human face or human body faces a direction other than front is set to none (unknown). FIGS. 28A and 28B exemplify the shooting possibility determination results based on a bias on a subject. In FIG. 28A, of the images of the camera A 1702 shown in FIG. 17A, shooting possibility determination results for the shooting angles of 0°, 60°, 180°, and 300° for which the person information is set to none (unknown) in FIG. 27A are set to off. In FIG. 28B, of the images of the camera B 1703 shown in FIG. 17B, shooting possibility determination results for the shooting angles of 0°, 60°, 180°, 240°, and 300° for which the person information is set to none (unknown) in FIG. 27B are set to off.

In step S2604, the control unit 411 determines whether personal authentication is performed for the images of all the shooting angles for which a shooting angle is a shooting target area and a human face or human body faces front. When personal authentication is performed for the images of all the shooting angles for which a shooting angle is a shooting target area and a human face or human body faces front, the process advances to step S2605. Upon determining that personal authentication is not performed for the images of all the shooting angles for which a shooting angle is a shooting target area and a human face or human body faces front, the process returns to step S2601 to continue the processing until personal authentication is performed for the images of all the shooting angles for which a shooting angle is a shooting target area and a human face or human body faces front.

In step S2605, the control unit 411 compares the feature amounts of persons obtained from the images for each shooting angle of each camera by personal authentication in step S2602. In the comparison of the feature amounts of persons, it is determined whether the same person is included in the images for each shooting angle of different cameras using a known method called matching. When the same person is included, person information in which the same index is added to the shooting angle of each camera is input. When the same person is not included, person information in which a unique index is added is input. In the example shown in FIGS. 27A and 27B, an index (person 1) indicating that the person in the image of a shooting angle of 120° in FIG. 27A is the same as the person in the image of a shooting angle of 120° in FIG. 27B is set.

In step S2606, the control unit 411 refers to the subject determination results shown in FIGS. 27A and 27B, and determines whether a person exists in the images of all the shooting angles of all the cameras. Upon determining that a person exists in the image of the determination target, the process advances to step S2607. Upon determining that no person exists in the image of the determination target, the process advances to step S2614.

In step S2607, the control unit 411 determines whether the person determined in step S2606 repetitively exists in the images of all the cameras. Upon determining that the same person exists in the images of all the cameras, the process advances to step S2610. Upon determining that the same person does not repetitively exist in the images of all the cameras (that is, the person exists only in the images of one camera), the process advances to step S2608. In the example shown in FIGS. 27A and 27B, it can be confirmed that the person in the image of the shooting angle of 120° of the camera A 1702 in FIG. 17A is the same as the person in the image of the shooting angle of 120° of the camera B 1703. In addition, since the person in the image of the shooting angle of 240° of the camera A 1702 in FIG. 17A does not exist in any one of the images of the camera B 1703 in FIG. 17B, it can be confirmed that the person is not a person repetitively existing in the images of all the cameras.

In step S2608, the control unit 411 sets the shooting possibility determination result of the shooting angle of the camera that has shot the person who does not repetitively exist in the images of all the cameras (that is, the person who exists only in the images of one camera) on. In the example shown in FIGS. 27A and 27B and FIGS. 28A and 28B, the shooting possibility determination result of the shooting angle of 240° in FIG. 28A, which corresponds to the shooting angle of 240° of the camera A 1702 in FIG. 17A that has shot the image of person 2 in FIG. 27A, is set to on.

Steps S2609 to S2612 indicate processing performed in a case where the same person exists in the images of all the cameras.

In step S2609, the control unit 411 compares the shooting conditions of all the cameras that shoot the same person. When the same person is shot by a plurality of cameras, the shooting conditions of the cameras are compared, and control is performed such that shooting is performed by the camera of the best shooting condition. The shooting condition is the position and size of a person. A state in which a subject is captured in a size that is larger than a predetermined size at a position close the center of the angle of view is defined as the best shooting condition. Note that the shooting condition is not limited to the position and size of a subject and may be the brightness of a face or an expression such as a smile.

In step S2610, the control unit 411 determines the camera of the best shooting condition based on the comparison result in step S2609.

In step S2611, the control unit 411 sets the shooting possibility determination result of the camera determined in step S2610 to on.

In step S2612, the control unit 411 sets the shooting possibility setting to off for cameras other than the camera determined in step S2610.

In the example shown in FIGS. 27A and 27B and FIGS. 28A and 28B, the shooting condition of the camera A 1702 in FIG. 17A, which shoots the image of person 1 in FIG. 27A, and the shooting condition of the camera B 1703 in FIG. 17B, which shoots the image of person 1 in FIG. 27B, are compared. Since the camera A 1702 in FIG. 17A captures person 1 at a position close to the center of the angle of view, it is determined that the shooting condition is good. The shooting possibility determination result of the shooting angle of 120° in FIG. 28A corresponding to the camera A 1702 in FIG. 17A is set to on, and the shooting possibility determination result of the shooting angle of 120° in FIG. 28B corresponding to the camera B 1703 in FIG. 17B is set to off.

In step S2613, the control unit 411 refers to the personal authentication results in step S2602 (the subject determination results shown in FIGS. 27A and 27B), and determines whether the processes of steps S2606 to S2612 are performed for all subjects shot by all the cameras. Upon determining that the processes are performed for all subjects shot by all the cameras, the processing is ended. Upon determining that the processes are not performed for all subjects shot by all the cameras, the process returns to step S2606 to continue the processing until the processes for all subjects of the cameras is completed.

Note that in the above-described example of control, the shooting angle is changed by pan-driving the camera. The shooting angle can also be changed by tilt driving or by combining pan driving and tilt driving. In this case, for shooting angles in tilt driving, a table of shooting possibility determination results is generated, like pan driving.

Also, control may be performed such that the frequency of shooting a main subject registered in advance becomes high, or control may be performed every time the position of the camera is changed.

As described above, according to the present embodiment, it is possible to perform shooting such that the shooting target or shooting range does not overlap between a plurality of cameras.

Note that various kinds of control described above as control to be performed by the control unit may be performed by one piece of hardware, or a plurality of pieces of hardware may control the entire apparatus by sharing processing.

According to the present disclosure, it is possible to perform shooting such that the shooting target or shooting range does not overlap between a plurality of image capture apparatuses.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-167823, filed Sep. 26, 2024 which is hereby incorporated by reference herein in its entirety.

What is claimed is:

1. An information processing apparatus comprising:
a memory and at least one processor which function as:
a communication unit that communicates with a plurality of image capture apparatuses each capable of changing a shooting direction;
an obtaining unit that obtains an image shot in each shooting direction from the plurality of image capture apparatuses;
a comparison unit that compares the images obtained from the plurality of image capture apparatuses; and
a control unit that controls, based on a result of the comparison, such that the shooting directions of the plurality of image capture apparatuses do not overlap.

2. The apparatus according to claim 1, wherein
wherein the control unit determines, from the images obtained from the plurality of image capture apparatuses, a shooting direction of a shooting target to be shot by the plurality of image capture apparatuses.

3. The apparatus according to claim 2, wherein
the information processing apparatus comprises a processing unit that performs subject detection processing for the images obtained from the plurality of image capture apparatuses, and
the control unit determines the shooting direction of the shooting target of the plurality of image capture apparatuses based on a result of the subject detection processing.

4. The apparatus according to claim 3, wherein
the control unit determines the shooting direction of an image in which a subject is detected by the subject detection processing as the shooting direction of the shooting target.

5. The apparatus according to claim 3, wherein
the control unit determines, as a non-target capturing direction, the shooting direction of an image in which no subject is detected by the subject detection processing.

6. The apparatus according to claim 5, wherein
the control unit determines shooting possibility for each shooting direction of the shooting target of the plurality of image capture apparatuses, and
the shooting possibility includes shooting enabled and shooting disabled.

7. The apparatus according to claim 6, wherein
the control unit determines whether the images obtained from the plurality of image capture apparatuses are similar,
compares the numbers of shooting directions of the shooting target of the plurality of image capture apparatuses that capture the similar images, and
when the numbers of shooting directions of the shooting target of the plurality of image capture apparatuses equal, sets the shooting direction of the shooting target of an image capture apparatus that has shot an image in which a position of the subject is closer to a center of the angle of view among the images obtained from the plurality of image capture apparatuses to shooting enabled, and sets the shooting direction of the shooting target of an image capture apparatus that has shot an image in which the position of the subject is not closer to the center of the angle of view to shooting disabled.

8. The apparatus according to claim 6, wherein
the control unit determines whether the images obtained from the plurality of image capture apparatuses are similar,
compares the numbers of shooting directions of the shooting target of the plurality of image capture apparatuses that capture the similar images, and
when the numbers of shooting directions of the shooting target of the plurality of image capture apparatuses are different, sets the shooting direction of an image capture apparatus for which the number of shooting directions of the shooting target is smaller to shooting enabled, and sets the shooting direction of an image capture apparatus for which the number of shooting directions of the shooting target is larger to shooting disabled.

9. The apparatus according to claim 6, wherein
the control unit determines whether the images obtained from the plurality of image capture apparatuses are similar, and
when the images obtained from the plurality of image capture apparatuses are not similar, the control unit sets the shooting direction of the shooting target of all the image capture apparatuses that have shot the images that are not similar to shooting enabled.

10. The apparatus according to claim 6, wherein
the determination of the shooting possibility is executed every time a position of one of the plurality of image capture apparatuses is changed.

11. The apparatus according to claim 6, wherein
the control unit sets a shooting direction determined as the non-shooting target for the shooting directions of the plurality of image capture apparatuses to shooting disabled.

12. The apparatus according to claim 7, wherein
the process returns to step determines whether the same subject exists in the images obtained from the plurality of image capture apparatuses,
compares shooting conditions of the plurality of image capture apparatuses that have shot the same subject, and
sets the shooting direction of the shooting target of an image capture apparatus for which the shooting condition satisfies a predetermined condition to shooting enabled, and sets the shooting direction of the shooting target of an image capture apparatus for which the shooting condition does not satisfy the predetermined condition to shooting disabled.

13. The apparatus according to claim 7, wherein
the control unit performs zoom for the shooting direction of the image capture apparatus set to shooting disabled.

14. The apparatus according to claim 1, wherein
the plurality of image capture apparatuses can rotate in a pan direction and a tilt direction, and
the shooting direction is a shooting angle divided into a predetermined angle in the pan direction and the tilt direction.

15. The apparatus according to claim 14, wherein
the plurality of image capture apparatuses can shoot omnidirectional images.

16. The apparatus according to claim 14, wherein
the plurality of image capture apparatuses perform first shooting based on a shooting instruction of the information processing apparatus or second shooting that is not based on the shooting instruction,
the shooting instruction includes a shooting instruction for each shooting angle, and
the plurality of image capture apparatuses perform shooting of a shooting angle set to shooting enabled based on the shooting instruction.

17. The apparatus according to claim 16, wherein
in the second shooting, the plurality of image capture apparatuses automatically perform the shooting of the shooting angle set to shooting enabled.

18. The apparatus according to claim 1, wherein
the information processing apparatus is an external apparatus different from the plurality of image capture apparatuses or one of the plurality of image capture apparatuses.

19. A control method of an information processing apparatus that communicates with a plurality of image capture apparatuses each capable of changing a shooting direction, comprising:
obtaining an image shot in each shooting direction from the plurality of image capture apparatuses;
comparing the images obtained from the plurality of image capture apparatuses; and
controlling, based on a result of the comparison, such that the shooting directions of the plurality of image capture apparatuses do not overlap.

20. A non-transitory computer-readable storage medium storing a program for causing a computer to function as an information processing apparatus comprising:
a communication unit that communicates with a plurality of image capture apparatuses each capable of changing a shooting direction;
an obtaining unit that obtains an image shot in each shooting direction from the plurality of image capture apparatuses;
a comparison unit that compares the images obtained from the plurality of image capture apparatuses; and
a control unit that controls, based on a result of the comparison, such that the shooting directions of the plurality of image capture apparatuses do not overlap.
